(19) United States
(12) Patent Application Publication
(10) Pub. No.: US 2008/0051921 A1
(43) Pub. Date: Feb. 28, 2008

(54) Method for modifying configuration of business system

(76) Inventor: Toshihiro Nammatsu, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/647,347

(22) Filed: Dec. 29, 2006

(30) Foreign Application Priority Data
Jul. 12, 2006 (JP) 2006-192042

(51) Int. Cl. G06F 19/00

(52) U.S. Cl. 700/97

(57) ABSTRACT

Configuration of a business program in a business system is modified by a managing computer using a script. Upon deployment of the business program, at least one business computer compatible with operating conditions of the business program is selected by performing a lookup on a first set of data. Programs prerequisite for the business program is searched for by performing a lookup on a second set of data. Differences in business system configuration information between pre-modification configuration and post-modification configuration of the business system are determined with respect to the business program and the programs prerequisite for the business program. Some of the plurality of script components required to apply the differences to the configuration of the business system is obtained, and arranged in an order determined on the basis of the prerequisite information, to compose the script. The business program is deployed to the at least one business computer by executing the composed script.

### CROSS-REFERENCE TO RELATED APPLICATION(S)

This application claims the foreign priority benefit under Title 35, United States Code, §119 (a)-(d), of Japanese Patent Application No. 2006-192042, filed on Jul. 12, 2006 in the Japan Patent Office, the disclosure of which is herein incorporated by reference in its entirety.

### BACKGROUND OF THE INVENTION

This invention relates generally to methods for modifying configuration of a business system comprised of a plurality of business programs deployed in at least one computer system, and more particularly to a technique for changing deployment of any of the business programs in a manner which has no or mitigated effects on the business system.

In recent years, many business systems, such as automatic teller machine (ATM) systems, point-of-sale (POS) systems, etc., are used in various business or non-profit organizations. The business systems, notably large-scale ones, are configured to have their business programs, data and the like (hereinafter referred to simply as “business programs”) deployed over a plurality of computer systems.

The business systems may have to modify their configuration, which modification may include addition, deletion, etc. of any of the business programs. In that event, manual modification of the business system configuration and various other settings associated therewith would entail not a little expense in time and labor; therefore, it would be desirable to automate as many steps as possible to be taken so that modification of configuration can be accomplished with increased ease.

For example, a dynamic flow determination apparatus disclosed in US 2001/0010056 A1 has proposed a system for dynamically determining a flow by means of an action chain in event processing performed in a distributed system in which a plurality of computers connected via a network operates in a coordinated manner, whereby part of system configuration or settings may be modified automatically.

However, the action chain as proposed is achieved by choosing actions to be executed upon receipt of any event object among executable actions on the basis of the type of the event object, and it would thus be necessary to have information on the types of all event objects, including the type of the received event object, beforehand.

In actuality, the events may vary according to individual products, and it is almost impossible to establish commonality in scheme of all the event objects. Even if such commonality in scheme of the event objects could be established, it is to be noted that there are numerous programs which issue events, and the number thereof will increase in future. Moreover, numerous developers of the programs which issue events actively works all over the world, and thus the number of types of the programs will increase in future. Accordingly, it would be very difficult to have all the information on the types of the event objects corresponding to the types of the programs which issue the events, which information should be recorded in predetermined definition fields of input patterns allocated in an action/attribute storage unit.

### SUMMARY OF THE INVENTION

The present invention has been made with consideration given to the above-described problems in the state-of-the-art technologies. It is an aspect of the present invention to modify configuration of a business system more easily even when the business system has a large-scale and complicate configuration.

A method consistent with the present invention relate to modification of a configuration of a business system embodied by at least one business computer executing a plurality of business programs. A managing computer communicatively coupled with the at least one business computer is provided to make such modification by means of a script. The managing computer comprises a processing unit and a storage unit. In the storage unit, business system configuration information, a first set of data, a second set of data and a plurality of script components are stored. The business system configuration information represents configuration of the plurality of business programs in the business system. The first set of data comprises operating condition information and business computer information which are associated with each other. The operating condition information represents conditions on which the plurality of business programs are operable, and the business computer information represents an identifier for the at least one business computer compatible with the operating conditions. The second set of data comprises prerequisite information representing programs which are prerequisite for the plurality of business programs and classified in program levels. The plurality of script components are provided for use in composing the script executable by the managing computer, and at least one parameter, which includes a parameter for specifying an identifier for the at least one business computer to be executed, is recordable into the plurality of script components.

The processing unit is caused, when deploying a business program, to execute the following steps of: selecting at least one business computer compatible with operating conditions of the business program by performing a lookup on the first set of data; searching for programs prerequisite for the business program by performing a lookup on the second set of data; determining differences in the business system configuration information between pre-modification configuration and post-modification configuration of the business system with respect to the business program and the programs prerequisite for the business program determined in the searching step; obtaining some of the plurality of script components required to apply the differences determined in the determining step, to the configuration of the business system, and arranging the obtained script components in an order determined on the basis of the prerequisite information, to compose the script; and deploying the business program to the at least one business computer selected in the selecting step, by executing the script composed in the obtaining and arranging step.

The other aspects, advantages and further features of the present invention will become readily apparent by describing in detail illustrative, non-limiting embodiments thereof with reference to accompanying drawings.

### BRIEF DESCRIPTION OF THE DRAWINGS

FIG. 1 is a diagram showing an outline of a program deployment system in an exemplary embodiment of the present invention.

FIG. 2 is a diagram showing a hardware arrangement of a program deployment system in an exemplary embodiment of the present invention.

FIG. 3 is a diagram showing a hardware arrangement of a business computer in an exemplary embodiment of the present invention.

FIG. 4 is a diagram showing elements of system configuration information in an exemplary embodiment of the present invention.

FIG. 5 is a diagram showing a program operating maximum configuration template in an exemplary embodiment of the present invention.

FIG. 6 is a diagram showing a program library management table in an exemplary embodiment of the present invention.

FIG. 7 is a diagram showing a script library management table in an exemplary embodiment of the present invention.

FIG. 8 is a diagram showing an operating system information management table in an exemplary embodiment of the present invention.

FIG. 9 is a diagram showing a business configuration information management table in an exemplary embodiment of the present invention.

FIG. 10 is a diagram showing a physical configuration information management table in an exemplary embodiment of the present invention.

FIG. 11 is a diagram showing a program configuration management table in an exemplary embodiment of the present invention.

FIG. 12 is a flowchart showing a main process flow in an exemplary embodiment of the present invention.

FIG. 13 is a diagram showing a screen representation of initial configuration of a business system in an exemplary embodiment of the present invention.

FIG. 14 is a diagram shoveling a screen representation of a configuration of the business system after business programs have been moved according to an exemplary embodiment of the present invention.

FIG. 15 is a diagram showing a screen representation of a configuration of the business system after business programs have been copied according to an exemplary embodiment of the present invention.

FIG. 16 is a diagram showing a screen representation of a configuration of the business system after a business program has been deleted according to an exemplary embodiment of the present invention.

FIG. 17 is a flowchart showing a process of selecting a destination computer to which a business program will be moved or copied, in an exemplary embodiment of the present invention.

FIG. 18 is a diagram showing a to-be-deployed program management table in an exemplary embodiment of the present invention.

FIG. 19 is a diagram showing a program configuration difference information management table in an exemplary embodiment of the present invention.

FIG. 20 is a flowchart showing a process of determining a program configuration difference in an exemplary embodiment of the present invention.

FIG. 21 is a diagram showing a script component in an exemplary embodiment of the present invention.

FIG. 22 is a diagram showing an operating system deploying script template in an exemplary embodiment of the present invention.

FIG. 23 is a diagram showing an operating system patch deploying script template in an exemplary embodiment of the present invention.

FIG. 24 is a diagram showing a program deploying script template in an exemplary embodiment of the present invention.

FIG. 25 is a diagram showing a program patch deploying script template in an exemplary embodiment of the present invention.

FIG. 26 is a diagram showing a program deleting script template in an exemplary embodiment of the present invention.

FIG. 27 is a diagram showing a program copying script scenario in an exemplary embodiment of the present invention.

FIG. 28 is a diagram showing a program deleting script scenario in an exemplary embodiment of the present invention.

FIG. 29 is a diagram showing a program moving script scenario in an exemplary embodiment of the present invention.

FIG. 30 is a flowchart showing a process of creating a copying script in an exemplary embodiment of the present invention.

FIG. 31 is a flowchart showing a process of establishing a program deploying script template in an exemplary embodiment of the present invention.

FIG. 32 is a flowchart showing a process of creating a program deleting script in an exemplary embodiment of the present invention.

FIG. 33 is a flowchart showing a process of assigning script components to a script template in an exemplary embodiment of the present invention.

FIG. 34 is a diagram showing a data model template for parameters in an exemplary embodiment of the present invention.

FIG. 35 is a flowchart showing a process of generating a data model in an exemplary embodiment of the present invention.

FIG. 36 is a flowchart showing a process of executing a script in an exemplary embodiment of the present invention.

FIG. 37 is a business configuration difference information management table in an exemplary embodiment of the present invention.

FIG. 38 is a group configuration difference information management table in an exemplary embodiment of the present invention.

FIG. 39 is a flowchart showing a process of creating the business configuration difference information management table in an exemplary embodiment of the present invention.

FIG. 40 is a flowchart showing a process of creating the group configuration difference information management table in an exemplary embodiment of the present invention.

FIG. 41 is a flowchart showing a process of copying, moving or deleting a business operation in an exemplary embodiment of the present invention.

### DETAILED DESCRIPTION OF THE EXEMPLARY EMBODIMENTS

A description will now be given of an exemplary embodiment of a program deployment system which implements a method for modifying a configuration of a business system by means of a script, with reference made to the drawings where appropriate.

The business system refers to a system configured to operate by a plurality of computers which are connected via a network and operate together in a coordinated manner to execute business operations or transactions. Those computers which operate in the business system will be hereinafter referred to as “business programs”.

The script is a simple computer-executable program which describes procedures for installation and/or configuration of other programs in a set of characters. The script is typically completed by setting parameters (e.g., business program identifiers, computer identifiers, etc.), and that which has not yet been completed with parameters is called “script scenario”.

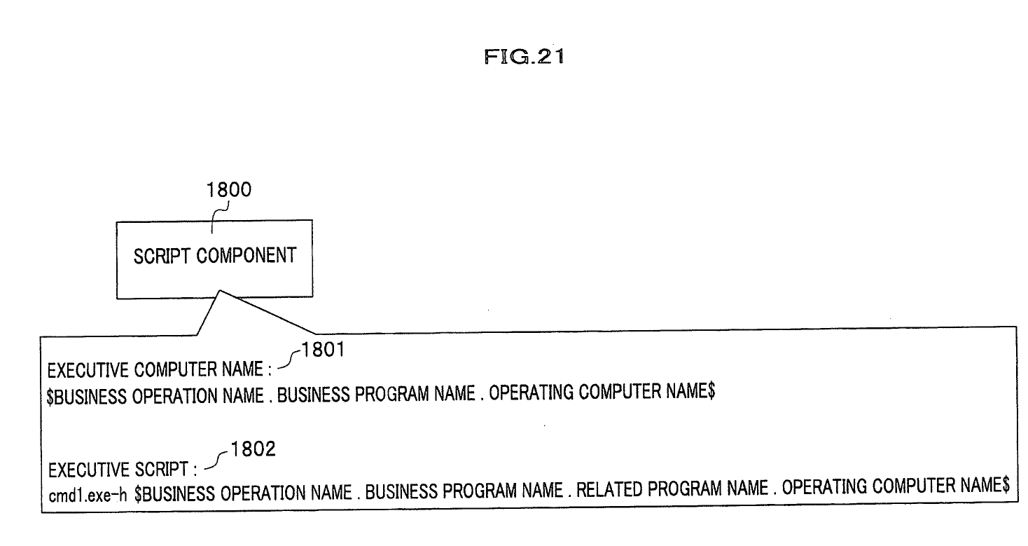

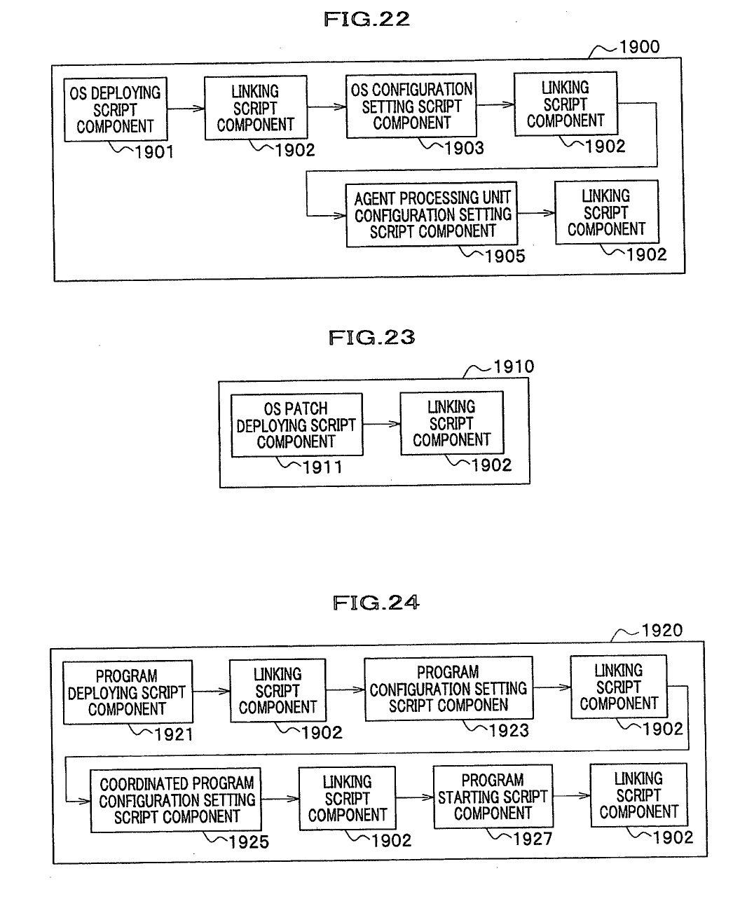

The script is composed of a plurality of script templates (prototype patterns of parts making up the script; for details, see FIGS. 22-26), and each script template is composed of a plurality of script components (unit components making up the script template; for details, see FIG. 21).

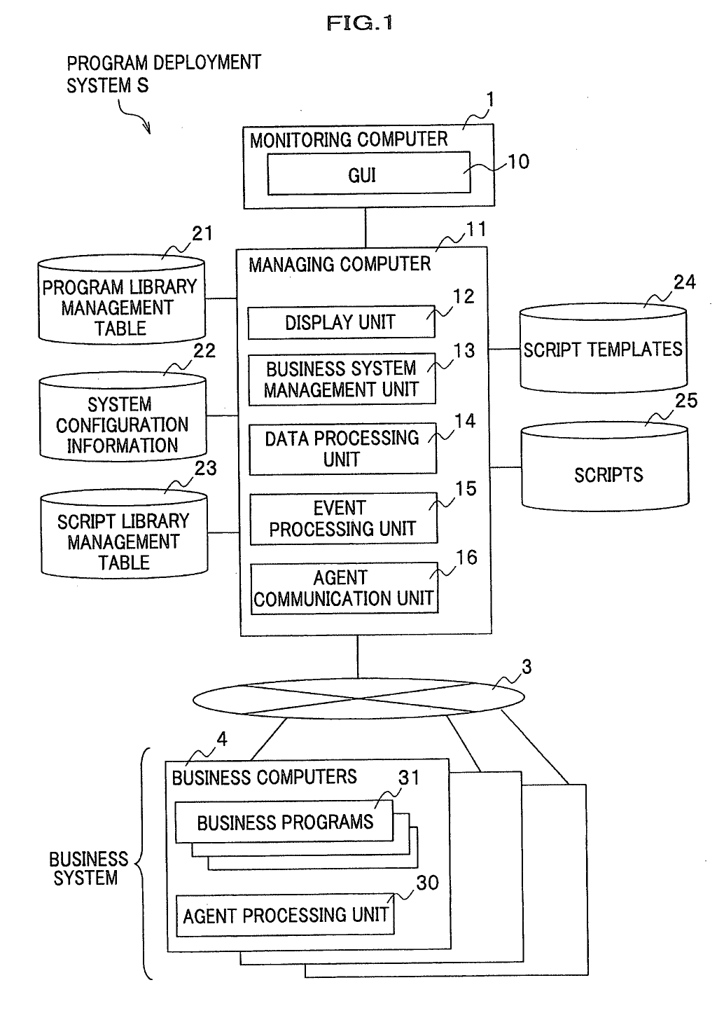

FIG. 1 is a diagram showing a general configuration of a program deployment system S in an exemplary embodiment of the present invention. As shown in FIG. 1, the program deployment system S according to the present embodiment includes a monitoring computer 1, a managing computer 11, and a plurality of business computers 4. The managing computer 11 and the plurality of computers 4 are connected via a network 3.

The monitoring computer 1 includes a graphical user interface or GUI 10 for graphically providing an operation screen with which an operator instructs the managing computer 11 to execute, via the network 3, a specified process of copying, moving or deleting a business program 31 so as to modify configuration of a business system.

The managing computer 11 includes a display unit 12, a business system management unit 13, a data processing unit 14, an event processing unit 15 and an agent communication unit 16.

The display unit 12 is a processing component for displaying a configuration of the business system on the GUI 10 (entry screen) of the monitoring computer 1 and receiving a request from the GUI 10. The business system management unit 13 is a processing component for managing a configuration of business programs 31 operating on each business computer 4 and updating system configuration information 22 (business system configuration information) when the configuration of the business system or business programs 31 are modified.

The data processing unit 14 is a processing component for performing reading/writing operations of various data such as in databases of program library management table 21, system configuration information 22, script library management table 23, script templates 24, and scripts 25. The event processing unit 15 is a processing component for creating a script 25 so as to realize a request received from the GUI 10 and a request involved in an event. The agent communication unit 16 is a processing component for communicating with an agent processing unit 30 of each business computer 4 to perform transmission/reception of requests and data.

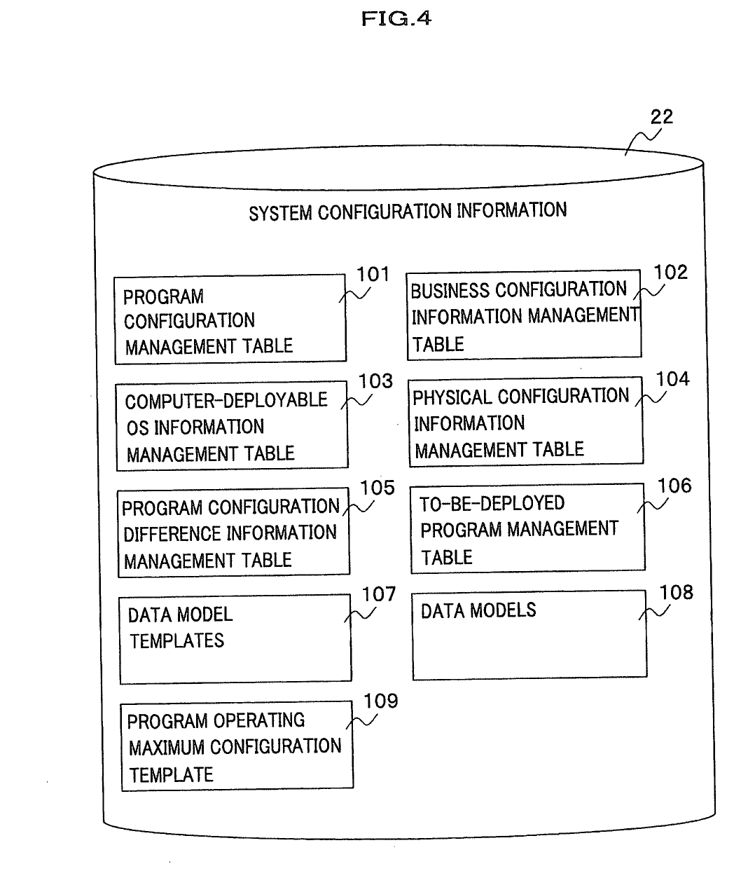

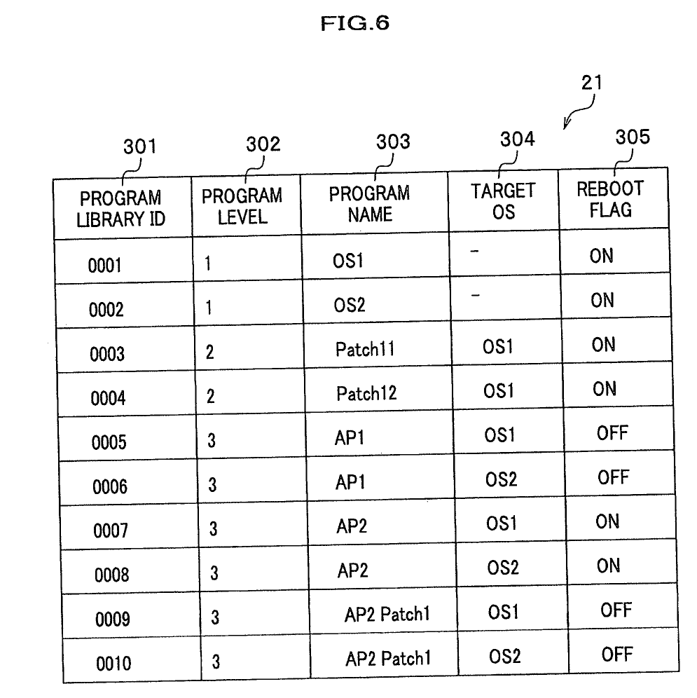

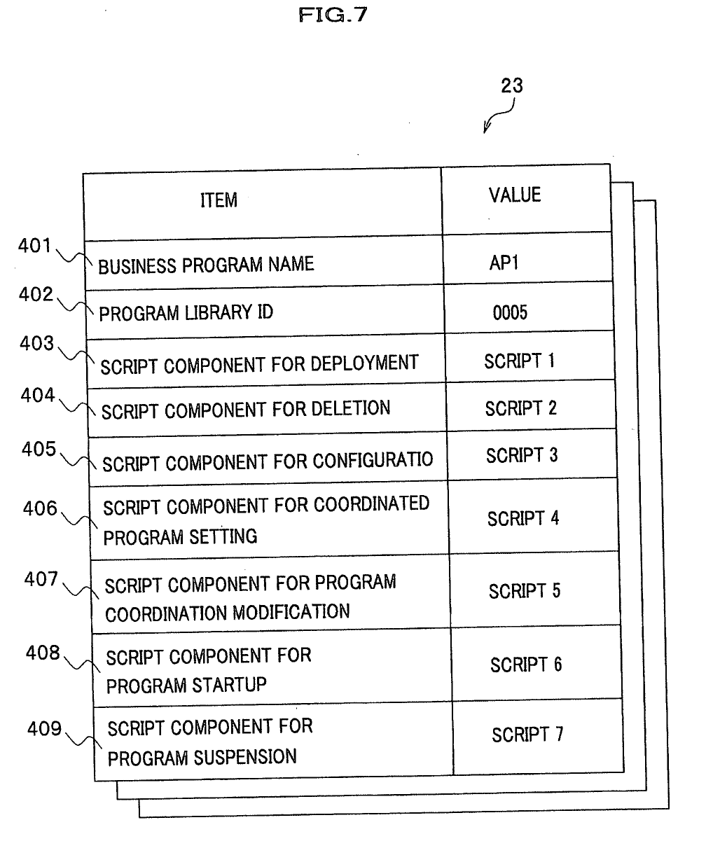

The various data the managing computer 11 handles include data in the databases of program library management table 21, system configuration information 22, script library management table 23, script templates 24, and scripts 25. The program library management table 21 is a table of information for use in management of program library (not shown) that holds installation images or disk images of each business program 31 for use in remote-installation or disk-copy operations, respectively, for deploying the business program 31 into a business computer 4 (exemplary items of information recorded in and managed with the program library management table 21 will be described later in more detail with reference to FIG. 6). The term “installation images” refers to archived data of each business program 31 in an installable form, whereas the term “disk images” refers to data of the business program 31 in an installed form which can be copied as is, from a hard disk in which the disk image is stored, to a destination storage medium. The system configuration information 22 holds information on configuration of a variety of business systems (exemplary items of the system configuration information 22 will be described later in more detail with reference to FIG. 4). The script library management table 23 holds script components which are executed to perform controlled operations of deployment, deletion, configuration setting and the like for each business program 31 (exemplary items of the script library management table 23 will be described later in more detail with reference to FIG. 7). The script templates 24 hold combination patterns of script components which are defined for application purposes. The scripts 25 are executable scripts each created by combining a script template and script components. In the present embodiment, the script templates 24 are a collection of typical examples (prototypes) of combination patterns of the script components.

Each business computer 4 includes a plurality of business programs 31 and an agent processing unit 30. The plurality of business programs 31 are executable programs for the business system. The agent processing unit 30 is used to communicate with the agent communication unit 16 of the managing computer 11. Although the present embodiment as shown in FIG. 1 illustrates an example of the business computer 4 which includes a plurality (three) of business programs 31, there may be provided in the business system business computers 4 including only one business program 31 and business computers 4 including no business program 31.

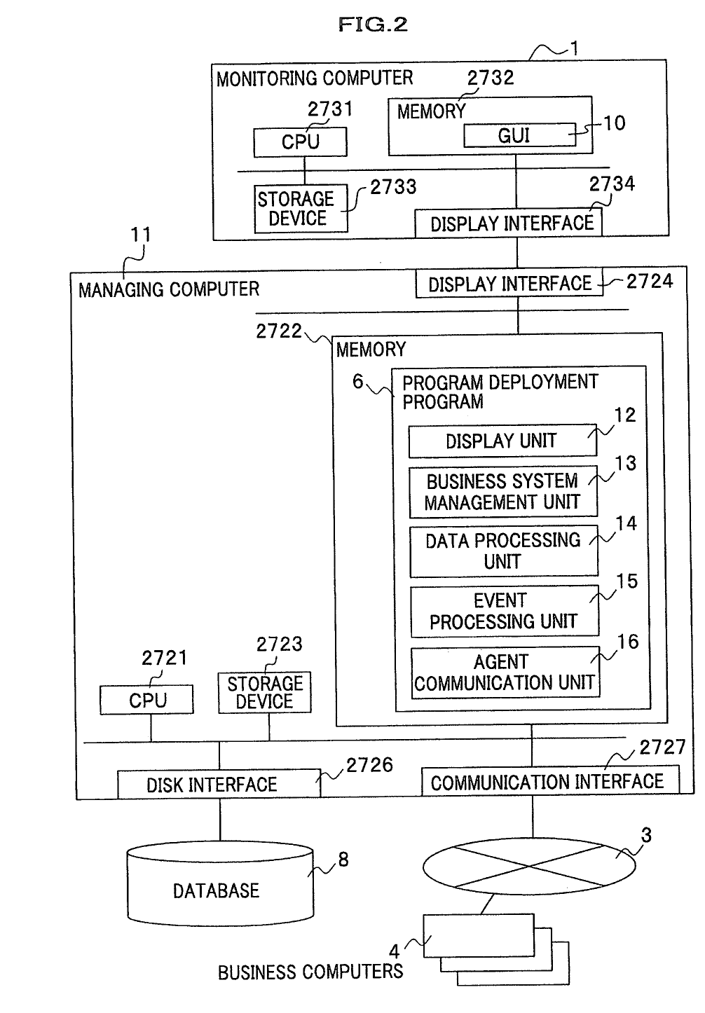

FIG. 2 is a diagram showing a hardware arrangement of a monitoring computer 1 and a managing computer 11 in one exemplary embodiment of the present invention. The managing computer 11 includes a central processing unit or CPU 2721 (processing unit), a memory 2722, a storage device 2723 (storage unit), a display interface 2724, a disk interface 2726 and a communication interface 2727; thus, the principal part of the program deployment system S may be implemented on a single unit of computer system (managing computer 11) as illustrated in this embodiment. The GUI 10 of the program deployment system S may be implemented as in this illustrated embodiment on the monitoring computer 1 which includes a CPU 2731, a memory 2732, a storage device 2733 and a display interface 2734.

In this embodiment, the display unit 12, business process unit 13, data processing unit 14, event processing unit 15 and agent communication unit 16 are embodied as a program deployment program 6 (managing program) of which components corresponding to the units 12-16 are stored in and respectively loaded from the storage device 2723 and executed in the memory 2722 by a CPU 2721. The managing computer 11 is connected with a database 8 established in an external storage device (storage unit) via a disk interface 2726, and connected with the business computers 4 via a communication interface 2727. The GUI 10 in the monitoring computer 1 may be implemented by a program (not shown) stored in the storage device 2733, which is loaded into the memory 2732 and executed therein by the CPU 2731. The program library management table 21, system configuration information 22, script library management table 23, script templates 24 and scripts 25 as shown in FIG. 1 may be stored, for example, in the database 8 as in this embodiment.

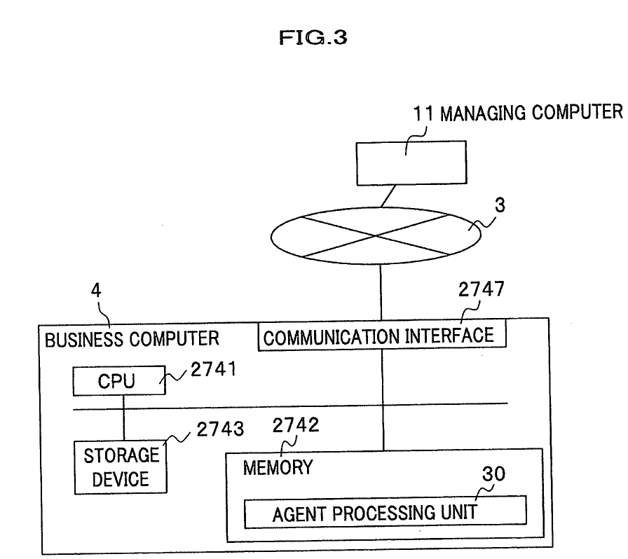

FIG. 3 is a diagram showing a hardware arrangement of a business computer 4 in an exemplary embodiment of the present invention. As shown in FIG. 3, the agent processing unit 30 of the business computer 4 may be embodied by a CPU 2741, a memory 2742, a storage device 2743 and a communication interface 2747. More specifically, in this embodiment, an agent program (not shown) stored in the storage device 2743 is loaded into the memory 2742 and executed therein by the CPU 2741 to thereby implement the agent processing unit 30. The business computer 4 is configured to establish connection, by means of the communication interface 2747, with the network 3 through which the business computer 4 is connected with the managing computer 11.

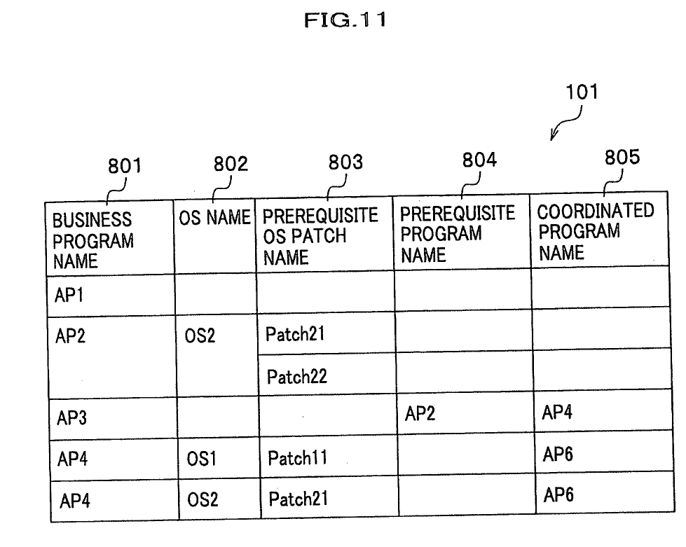

FIG. 4 is a diagram showing various tables or other elements of system configuration information 22 in an exemplary embodiment of the present invention. In the system configuration information 22, a program configuration management table 101 (second set of data) includes information on OS (operating system) patches prerequisite for each business program 31, information on programs prerequisite for each business program 31, and information on programs operating in coordination with each business program 31, which are user-defined information that has been entered in advance. Exemplary items of information recorded in and managed with the program configuration management table 101 will be described later in more detail with reference to FIG. 11.

The term “patches” refers to files (patch files) of program subsets corresponding to portions of a program to be updated by modification, for use in modifying the program, which are extracted and enumerated from the program (i.e., differences in the program between pre-modification and post-modification). The term “prerequisite” is used in such an expression that a program A is prerequisite for another program B to mean that the program B is necessary for execution of the program A.

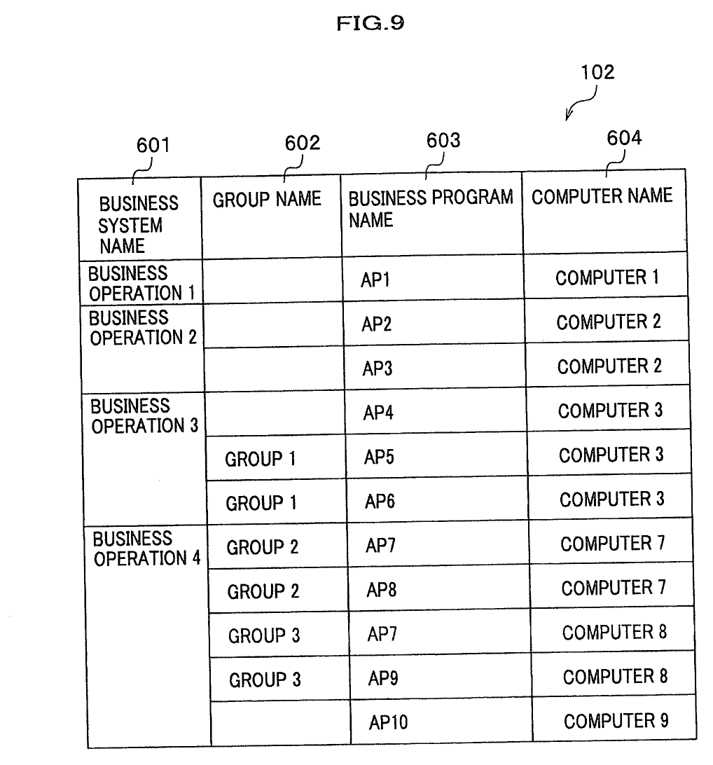

A business configuration information management table 102 includes business program names (identifiers) of business programs 31 each responsible for a business process and names (identifiers) of computers 4 on which each business program 31 is in operation (deployed and executed), which are associated with each other in accordance with user's definition. Exemplary items of information recorded in and managed with the business configuration information management table 102 will be described later in more detail with reference to FIG. 9.

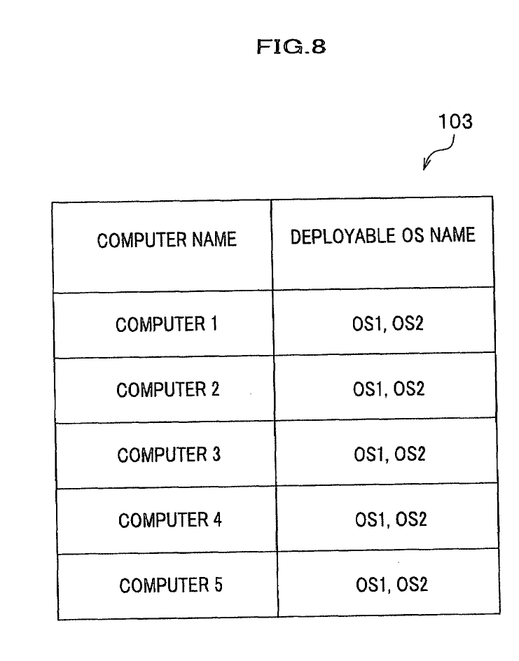

An OS (operating system) information management table 103 (first set of data) is user-defined information on operating systems deployable in each business computer 4. Exemplary items of information recorded in and managed with the OS information management table 103 will be described later in more detail with reference to FIG. 8.

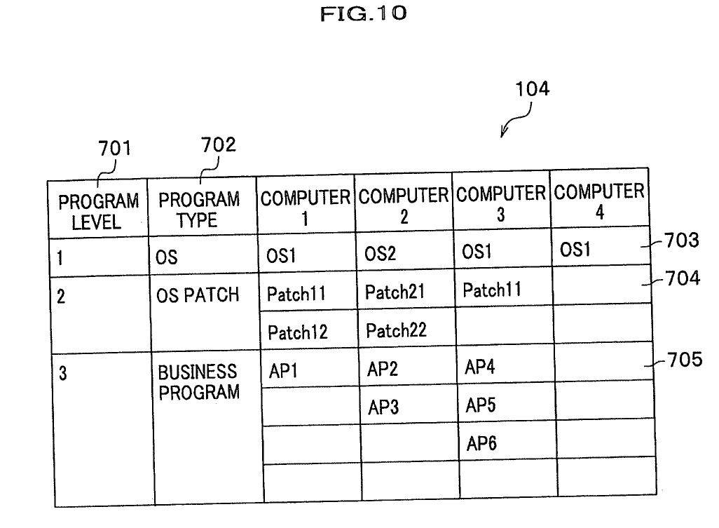

A physical configuration information management table 104 (second set of data) is a collection of physical information, which may include OS information, OS patch information, deployed program information, etc. of each business computer 4 managed by the program deployment system S. Exemplary items of information recorded in and managed with the physical configuration information management table 104 will be described later in more detail with reference to FIG. 10.

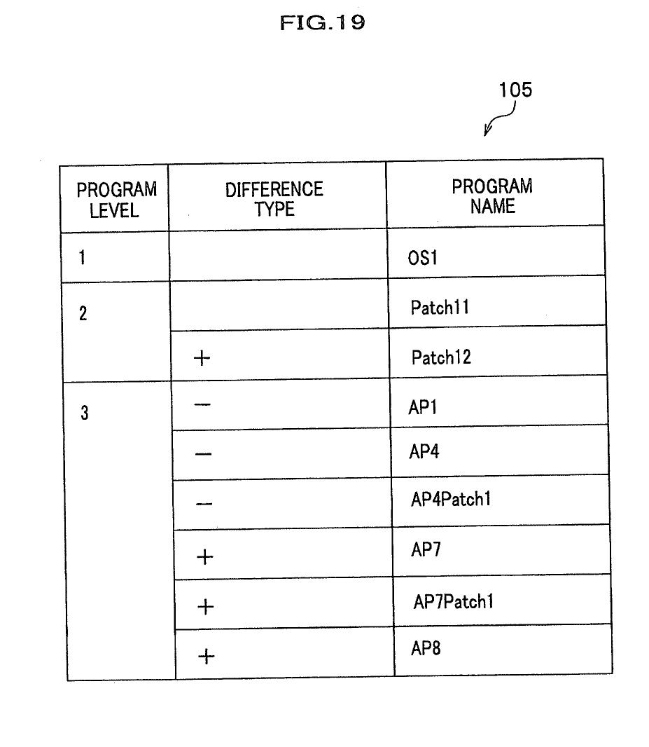

A program configuration difference information management table 105 holds difference information between a pre-modification configuration and a post-modification configuration in a business computer 4 to which a business program 31 is to be deployed. Exemplary items of information recorded in and managed with the program configuration difference information management table 105 will be described later in more detail with reference to FIG. 19.

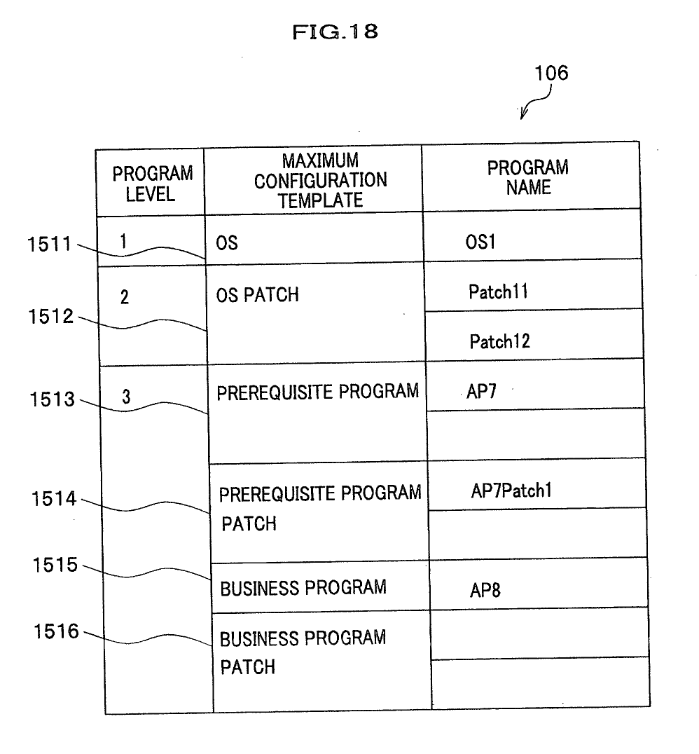

A to-be-deployed program management table 106 holds information on programs required for a business computer 4 to which a business program 31 is to be deployed, when the business program 31 is copied or moved thereto. Exemplary items of information recorded in and managed with the to-be-deployed program management table 106 will be described later in more detail with reference to FIG. 18.

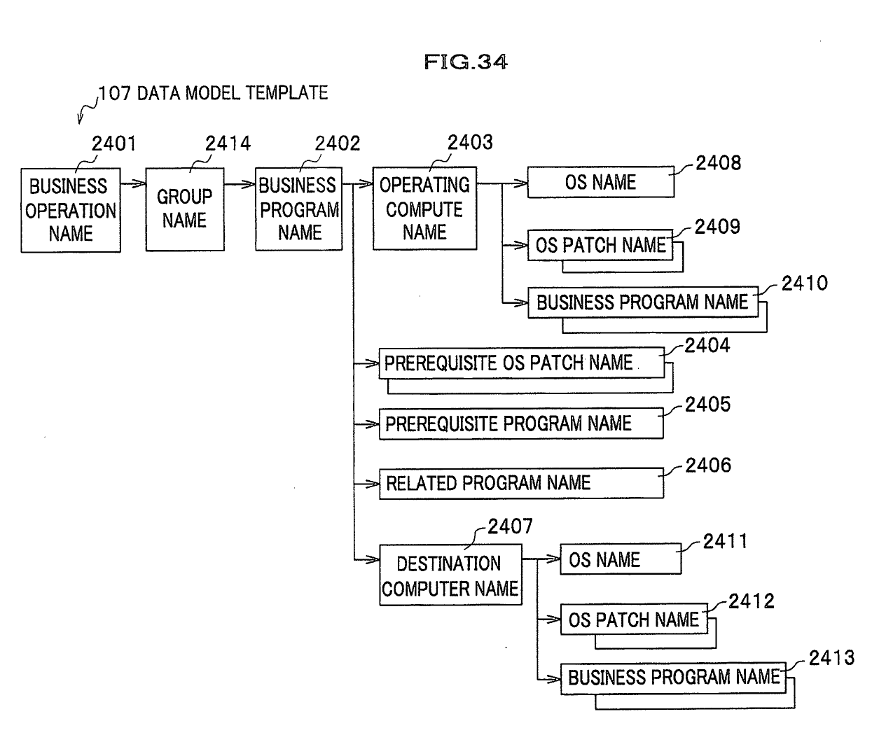

Data model templates 107 are data structures defined for respective business programs 31 in conjunction with a business system. An exemplary data structure defined in the data model templates 107 will be described later in more detail with reference to FIG. 34.

Data of the business system are incorporated into a data model template 107 to generate a data model 108. In other words, the data model 108 is generated by completing the data model template 107 with some programs added thereto or deleted therefrom and data embedded therein, on an as needed basis.

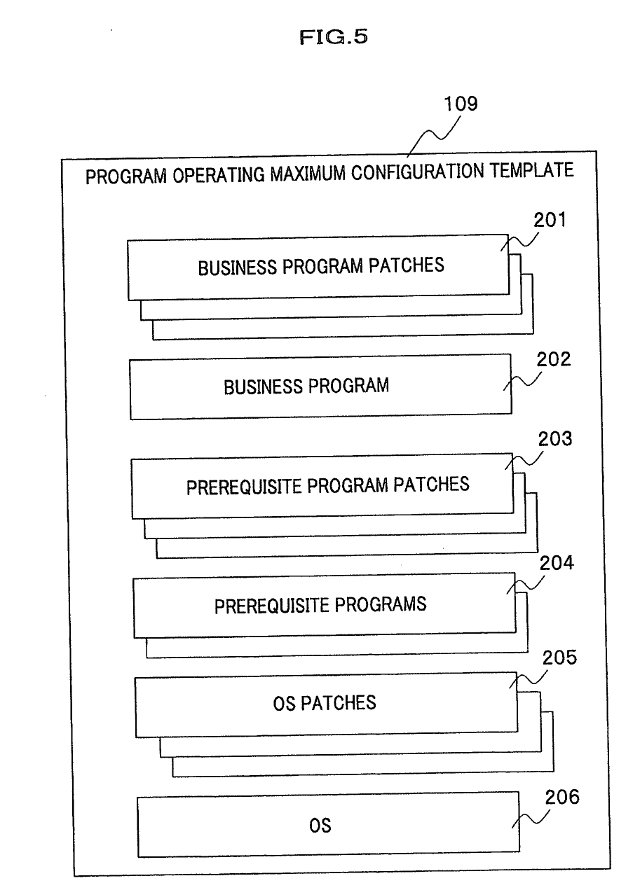

A program operating maximum configuration template 109 is a template of a configuration defined as the maximum program configuration required to make the business program 31 to operate. FIG. 5 is a diagram showing an example of the program operating maximum configuration template 109. Typically, the maximum program configuration required for operation of a business program 202 comprises an operating system (OS) 206, OS patches 205 prerequisite for the business program 202, prerequisite programs 204 (i.e., business programs prerequisite for the business program 202), prerequisite program patches 203 (i.e., patches for the prerequisite programs 204), the business program 202, and business program patches 201 (i.e., patches for the business program 202), which are combined together.

In some instances, the OS patches 205, the prerequisite programs 204, the prerequisite program patches 203 and the business program patches 201 may not be required, while in other instances, more than one program 204 and patch (205, 203, 201) may be required as in the illustrated embodiment. When the program operating maximum configuration template 109 is used to deploy a business program 202, those data which are defined in the program operating maximum configuration template 109 are adopted, as programs required for deployment of the business program 202 to the business computer 4, to generate the to-be-deployed program management table 106.

FIG. 6 is a diagram showing an example of the program library management table 21. The program library (not shown) holds disk images or installation images of OSes, OS patches, business programs, business program patches, and the like, which images are manageably recorded in the program library management table 21. The program library management table 21 holds a program library ID 301 uniquely identifying each disk or installation image for managerial use. Hereupon, it is to be understood that the OS disk image is a disk image of a pre-configured operating system in which an agent processing unit 30 has been installed beforehand, and thus deployment of the operating system using the OS disk image results in simultaneous deployment of the agent processing unit 30.

The program library management table 21, in this embodiment, holds user-defined information on a program name 303 (i.e., identifier of a program such as OS, program, patch, etc.), a target OS 304 (i.e., the name or identifier of OS to which the program is deployable), and a reboot flag 305 (reboot indicator) for indicating whether or not deployment of the program specified by the program name 303 requires rebooting (restarting) the deployed business computer. For programs compatible with a plurality of operating systems, different program library IDs 301 are assigned to the same programs running on different operating systems.

The programs in the program library management table 21 as illustrated in FIG. 6 according to the present embodiment are classified in program levels (see the field or column of a program level 302); program level ‘1’ denotes an operating system, program level ‘2’ denotes an OS patch, and program level ‘3’ denotes a business program or a patch for the business program. The program level 302 of the program library management table 21 is determined by consulting the program configuration management table 101 under ‘OS name 802’ and ‘prerequisite OS patch name 803’ (see FIG. 11); that is, if the program name 303 matches any of the OS names 802 held in the program configuration management table 101, then the program level ‘1’ is assigned, if the program name 303 matches any of the prerequisite OS patch names 803 held in the program configuration management table 101, then the program level ‘2’ is assigned, and otherwise, the program level ‘3’ is assigned.

In the reboot flag 305 field, OFF (indicative of ‘not rebooting’) is set as an initial value which is retained unless a user specifies that the reboot flag is set (i.e., the value therein is turned ON) for each record identified by the program library ID. However, if a program returns a reboot request upon completion of deployment, the business computer to which the program is assigned is caused to reboot even when the reboot flag is not set (i.e., OFF is set in the reboot flag 305 field) for the program.

FIG. 7 is a diagram showing a script library management table 23 in an exemplary embodiment of the present invention. The script library management table 23 is configured to hold a variety of script components for each business program. The script components stored in the script library management table 23 includes user-defined scripts (subsets) as illustrated in FIG. 21, for use in controlling a program.

The script components may include a script component for deployment 403, a script component for deletion 404, a script component for configuration 405, a script component for coordinated program setting 406, a script component for modification of program coordination modification 407, a script component for program startup 408, and a script component for program suspension 409, all of which are recorded for each business program to which is assigned a business program name 401 corresponding uniquely to a program library ID 402. The script component for deployment 403 includes a set of instructions for deploying a disk image or an installation image of a target program (e.g., a business program to be deployed, an OS, an OS patch, etc.) into a destination storage medium. The script component for deletion 404 includes a set of instructions for deleting the target program. The script component for configuration 405 includes a set of instructions for setting up the configuration of the target program. The script component for coordinated program setting 406 includes a set of instructions for setting information on a program which works in a manner coordinated with the target program. The script component for program coordination modification 407 includes a set of instructions for modifying information on a program which works in a manner coordinated with the target program (such as the target program, or its location, with which the program works in coordination). The script component for program startup 408 includes a set of instructions for starting the target program. The script component for program suspension 409 includes a set of instructions for suspending the target program.

Each script component may be provided for each of different operating systems. Any script component if not required for deployment (or modification in configuration) of the business program, may be omitted. The script component for deployment 403 is typically designed to install remotely (i.e., via the network 3) the disk image or installation image of a business program (and any other target programs) identified by the program library ID 402, unless otherwise specified by a user.

FIG. 8 is a diagram showing an example of the operating system information management table 103, which holds information on operating systems deployable in each business computer 4. In this table 103, user-defined information on interchangeable (deployable) operating systems (operating conditions) is recorded.

FIG. 9 is a diagram showing an example of the business configuration information management table 102, which manageably holds information on business computers making up the business system (each business operation thereof) and names of computers on which the business programs operate. In this table 102, information on a business system name 601, a group name 602, a business program name 603 and a computer name 604 is recorded. The business system name 601 is representative of the names of business operations implemented in the business system. The group name 602 is provided for use in efficiently managing a plurality of business programs in groups, but may not necessarily be provided as the case may be. The business program name 603 holds information on names of business programs used for achieving each business operation of the business system. The computer name 604 holds information on names of computers in which each business program is executed. The business configuration information management table 102 is created on the basis of user's definition at the outset, and when the configuration of the business system is modified as a result of an operation of copying, moving or deleting any business program, any such modifications are reflected by the program deployment system S in the table 102.

FIG. 10 is a diagram showing an example of the physical configuration information management table 104, which manageably holds a physical configuration of each business computer 4 which operates under control of the program deployment system S according to the present embodiment. In this table 104, information on programs is classified into program types 702, which include an OS 703, an OS patch 704 and a business program 705, and is recorded for each computer (of computers 1-4). The program types 702 correspond to program levels 701. In this example, the fields in a row 703 labeled with ‘OS’ in program type 702 hold information on the names of OSes, such as OS1, OS2, etc., all of which are assigned to program level ‘1’; the fields in rows 704 labeled with ‘OS patch’ in program type 702 hold information on the names of OS patches, such as Patch 11, Patch 12, Patch 21 and Patch 22, all of which are assigned to program level ‘2’; and the fields in rows 705 labeled with ‘business program’ in program type 702 hold information on the names of business programs, such as AP1, AP2, AP3, AP4, AP5 and AP6, all of which are assigned to program level ‘3’. In an exemplary embodiment, information on the names of OSes, OS patches and programs deployed in the business computers 4 is retrieved from the agent processing unit 30 of each business computer 4, and sorted into program levels, to create the physical configuration information management table 104 stored in the database 8.

FIG. 11 is a diagram showing an example of the program configuration management table 101, which manageably holds information on configuration of each business program. In this table 101, information on the names of OSes prerequisite for each business program (OS name 802), the names of prerequisite OS patches (prerequisite OS patch name 803), the names of prerequisite business programs (prerequisite program name 804) and the names of coordinated programs (coordinated program name 805) is recorded for each business program identified by the name of the business program stored in the business program name 801. Business programs may not require any of a prerequisite OS, OS patch or program, or a coordinated program, and thus any of the fields 802, 803, 804 and 805 of such business programs may be left blank. The program configuration management table 101 is created on the basis of user's definition.

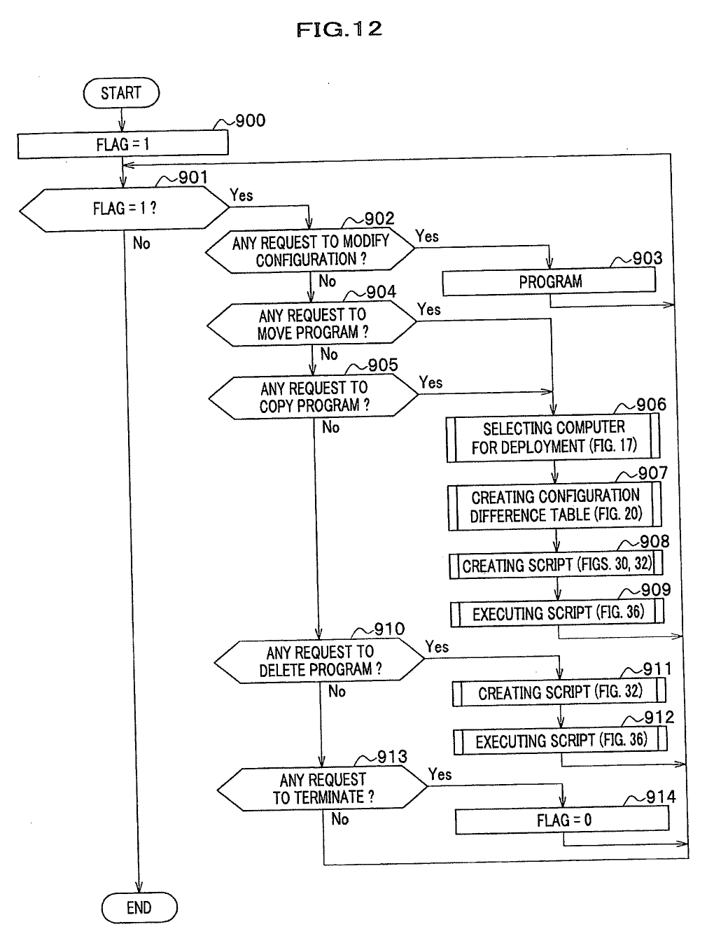

FIG. 12 is a flowchart showing a main process flow of a program deployment system in one exemplary embodiment of the present invention. First of all, in brief outline, the program deployment system S in the present embodiment waits until a request to move, copy or delete (hereinafter referred simply to ‘modify’) a business program is made by an operator through the GUI 10, or a request event as such takes place. Once such a request or request event is received, a script for achieving the request is created and executed, and if the request involves any modification in business system configuration, the information on the business system configuration is retrieved from the agent processing unit 30 of each business computer 4, to reflect the modification in the business configuration information management table 102 and the physical configuration information table 104. The program deployment system S terminates its process in response to an ending request or event.

More specifically, in the managing computer 11, the CPU 2721 loads the program deployment program 6 stored in the storage device 2723 onto the memory 2722, to execute the processes as illustrated in FIG. 12 (and subroutines illustrated in the other drawing figures corresponding to steps 906-912) as follows.

First, when a request is received or a request event takes place to modify a business program, ‘1’ is set to a flag in step 900. Next, it is determined in step 901 whether or not the flag=‘1’, and if it is determined that the flag=“1” (Yes in step 901), then the process goes to step 902. If it is determined that the flag is not ‘1’ (No in step 901), then the process is terminated.

It is determined in step 902 whether or not a request to modify configuration of the business system, such as a request to copy, move or delete any business program, is received through the GUI 10, and if it is determined that such a request to modify the configuration of the business system is received (Yes in step 902), then the process goes to step 903, but otherwise (No in step 902), the process goes to step 904.

In step 903, modification in the configuration is reflected in the business configuration information management table 102, whereas information on programs deployed in each business computer 4 is retrieved from the agent processing unit 30 of the business computer 4 in which a program has been moved, copied or deleted, and thus the physical configuration information management table 104 is updated. Thereafter, the process goes back to step 901.

It is determined in step 904 whether or not a request to move a business program is received, and it is determined in step 905 whether or not a request to copy a business program is received. If it is determined in step 904 or 905 that such a request is received (Yes in either step 904 or 905), then the process goes to step 906, but otherwise (No in both steps 904 and 905), the process goes to step 910.

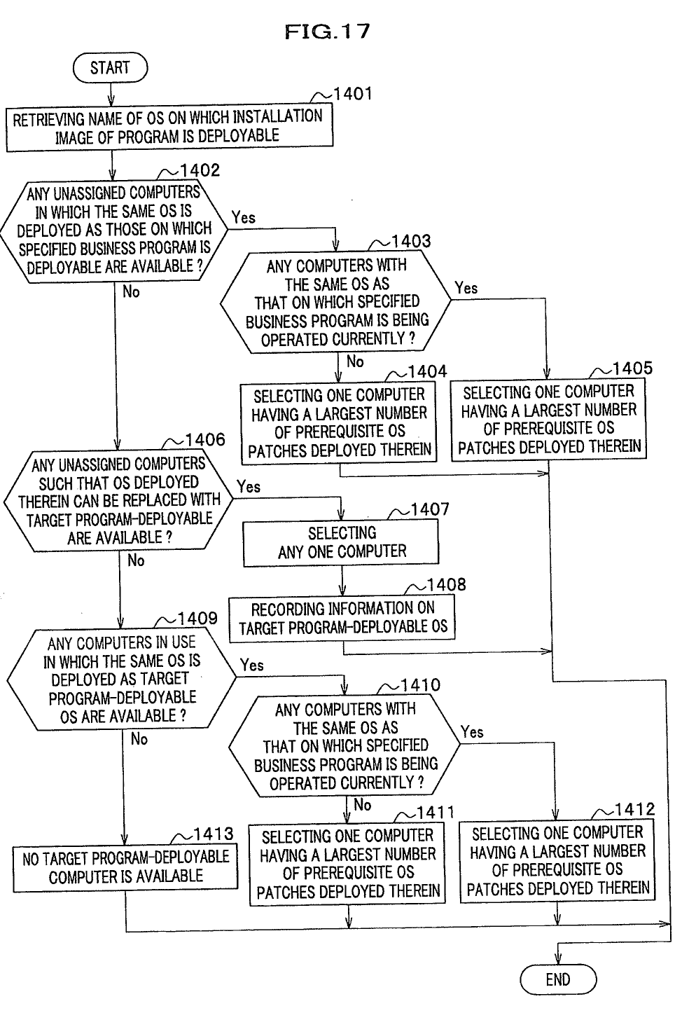

In step 906, a computer in which the target business program is deployable is selected on the basis of a variety of information of the target business program (for details, see a description that will be given later with reference to FIG. 17), and the process goes to step 907.

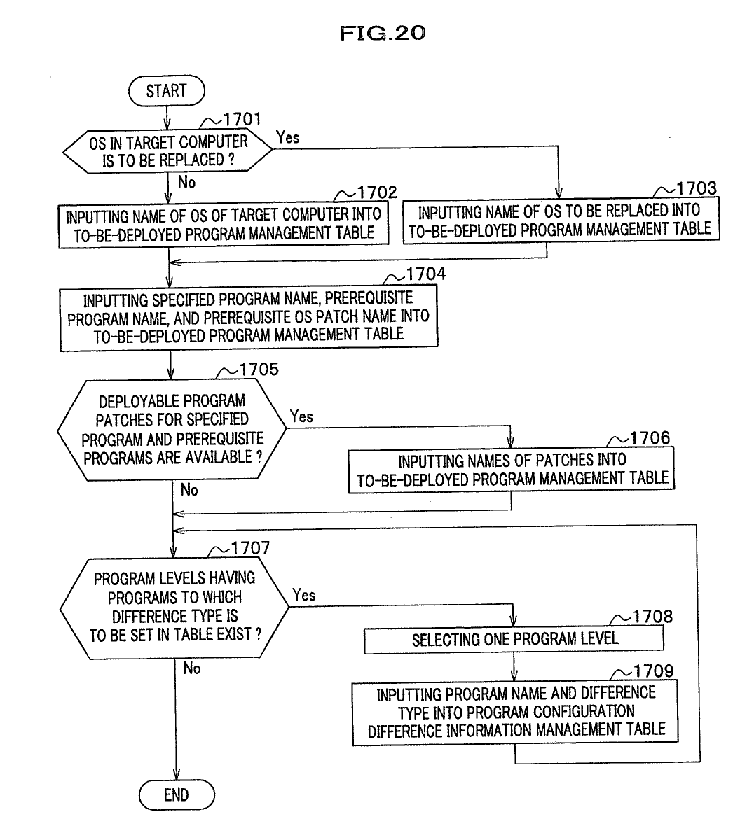

In step 907, a program configuration difference information management table 105 is created for the business computer to which the program is to be deployed (for details, see a description that will be given later with reference to FIG. 20), and the process goes to step 908.

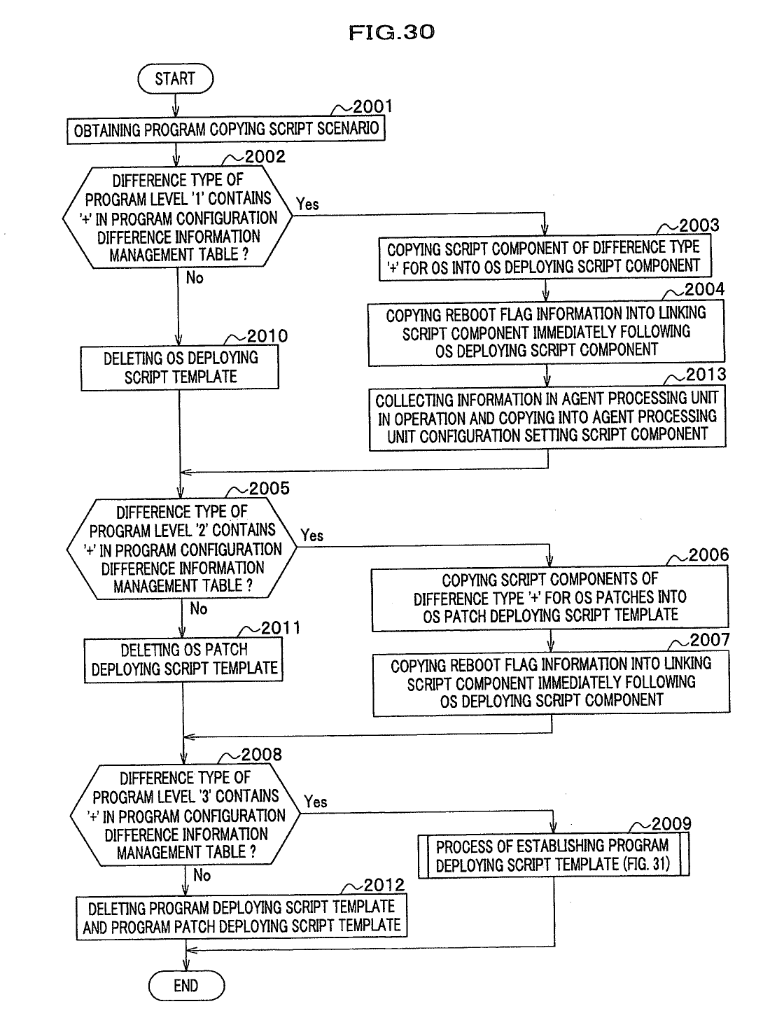

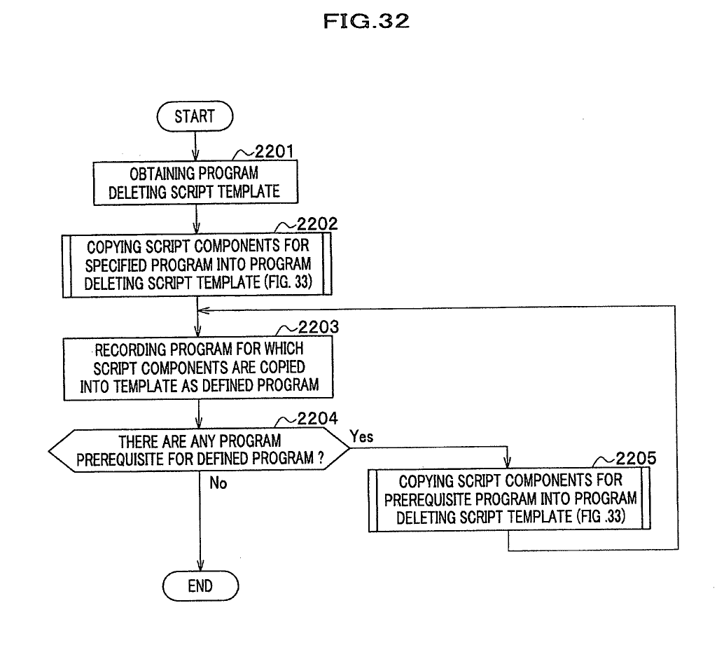

In step 908, a script for achieving the request is created on the basis of the program configuration difference information management table 105 created in step 907 (for details, see a description that will be given later with reference to FIGS. 30 and 32), and the process goes to step 909.

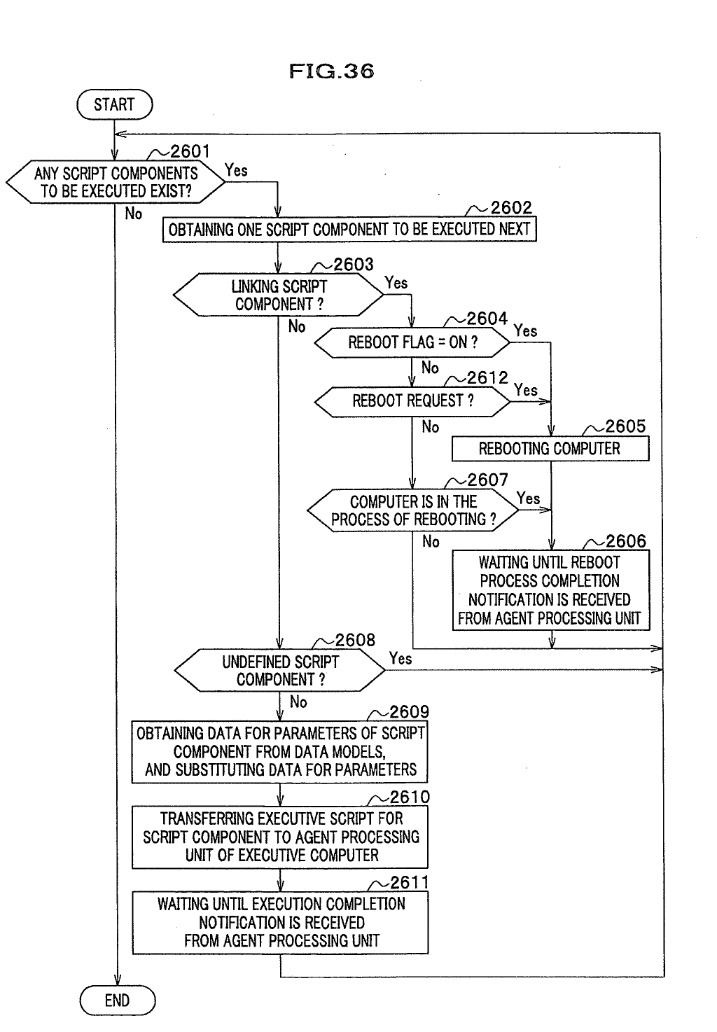

In step 909, the script created in step 908 is executed (for details, see a description that will be given later with reference to FIG. 36) to achieve the request, and the process goes back to step 901.

It is determined in step 910 whether or not a request to delete a business program is received, and if it is determined that such a request is received (Yes in step 910), then the process goes to step 911, but otherwise (No in step 910), the process goes to step 913.

In step 911, a script for deleting the business program according to the request is created (for details, see a description that will be given later with reference to FIG. 32), and the process goes to step 912.

In step 912, the script created in step 911 is executed (for details, see a description that will be given later with reference to FIG. 36) to achieve the request, and the process goes back to step 901.

It is determined in step 913 whether or not a request to terminate the program deployment system S is received, and if it is determined that such a request is received (Yes in step 913), then the process goes to step 914, but otherwise (No in step 913), the process goes back to step 901.

In step 914, ‘0’ is set to the flag, and the process goes back to step 901.

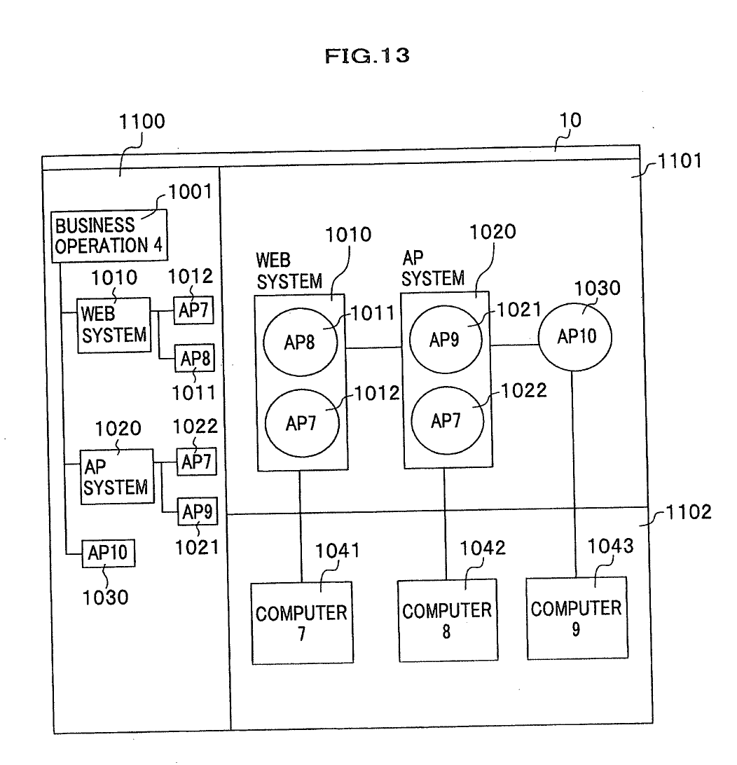

Referring now to FIGS. 13-16, varying screen representations displayed in the GUI 10 during the process of modifying the configuration of the business system will be presented by way of example. A detailed description of specific process steps in the program deployment system S, which presents the screen representations as illustrated in FIGS. 13-16 will be given with reference to FIGS. 17 and subsequent drawing figures.

FIG. 13 is a diagram showing an example of a screen representation of configuration of the business system, displayed in the GUI 10 of the monitoring computer 1 in an exemplary embodiment of the present embodiment. Herein, the GUI 10 provides a business configuration field 1100 in which the configuration of the business system is hierarchically represented, a coordination configuration field 1101 in which coordination of the business programs is represented, and a physical configuration field 1102 in which business computers for use in executing the business programs are represented.

The business configuration field 1100 is designed to hierarchically represent a business system name 601 (e.g., denoted by reference numeral 1001 is ‘business operation 4’), a group name 602 (e.g., denoted by reference numeral 1010 is a Web system, and denoted by reference numeral 1020 is an application (AP) system) and a business program name 603 (e.g., denoted by reference numeral 1011, 1012, 1021, 1022, and 1030 are business programs or application programs AP8, AP7, AP9, AP7 and AP10, respectively), based upon data of user-defined information recorded in the business configuration information management table 102 (see FIG. 9).

The coordination configuration field 1101 is designed to represent the business programs, coordinated programs (programs each of which operates in a manner coordinated with a business program associated therewith), and their associations, based upon data of user-defined information on the coordinated program name 805 recorded in the program configuration management table 101 (see FIG. 11).

The physical configuration field 1102 is designed to represent the names of computers and associations of the computers with the programs (coordinated programs) which operate thereon, based upon data of user-defined information on the computer name 604 recorded in the business configuration information management table 102 (see FIG. 9).

In the example illustrated in FIG. 13, the business operation 4 (denoted by reference numeral 1001; note that the reference numeral denoting each element of the screen representation will hereinafter be referred to simply by an appended number parenthesized or unparenthesized) comprises a Web system 1010, an AP system 1020 and an AP10 (1030). The Web system 1010 comprises a business program AP8 (1011) and a prerequisite program AP7 (1012) both of which operate on the computer 7 (1041) in a manner coordinated with the AP system 1020. The prerequisite program AP7 (1012) in the Web system 1010 is a program prerequisite for the business program AP8 (1011). The AP system 1020 comprises a business program AP9 (1021) and a prerequisite program AP7 (1022) both of which operate on the computer 8 (1042) in a manner coordinated with the AP10 (1030). The prerequisite program AP7 (1022) in the AP system 1020 is a program prerequisite for the business program AP9 (1021). The AP10 (1030) operates on the computer 9 (1043).

In operation, when an operator is going to make a request to copy, move or delete a business program through the GUI 10, the operator may specify the business program by clicking on the program represented in the business configuration field 1100 or in the coordination configuration field 1101, and then select a type of operation among COPY, MOVE and DELETE.

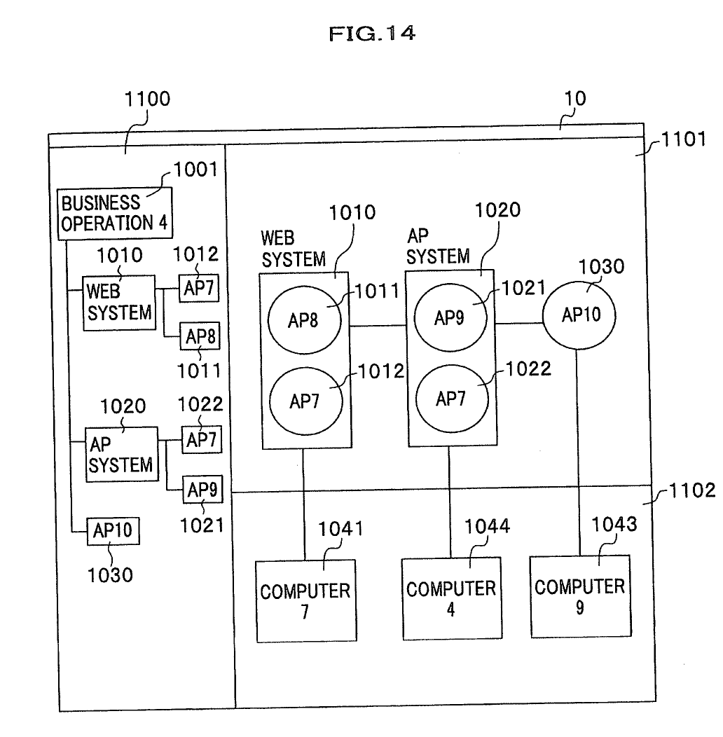

FIG. 14 is a diagram showing an example of the screen representation of configuration of the business system after business programs have been moved according to an exemplary embodiment of the present invention.

When a request is received from a user or a request event takes place to move a business program, the managing computer 11 in the program deployment system S according to the present embodiment selects a computer to which the given business program can be moved, and creates and executes a deleting script. Thereafter the managing computer 11 updates information on the configuration of the business system, which is reloaded in the monitoring computer 1 so that the up-to-date information is displayed in each field of the GUI 10.

The example of the screen representation illustrated in FIG. 14 is that which is shown after the AP9 (1021) of the business operation 4 (1001) in FIG. 13 is moved. To be more specific, the AP9 (1021) is moved together with the prerequisite program AP 7 (1022) from the computer 8 (1042) to another computer 4 (1044). Thus the programs AP9 (1021) and AP7 (1022) are deleted from computer 8 (1042), with the result that the computer 8 (1042), in which the programs AP9 (1021) and AP 7 (1022) were deployed before the moving operation, is deallocated.

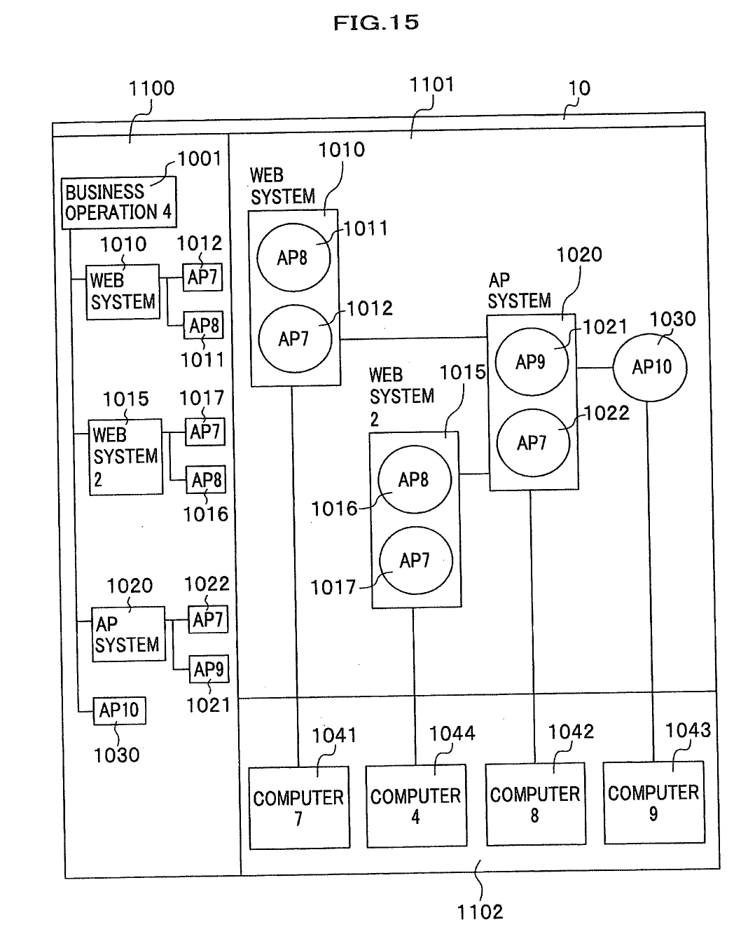

FIG. 15 is a diagram showing an example of the screen representation of configuration of the business system after business programs have been copied according to an exemplary embodiment of the present invention.

When a request is received from a user or a request event takes place to copy a business program, the managing computer 11 in the program deployment system S according to the present embodiment selects a computer to which the given business program can be copied, and creates and executes a copying script. Thereafter the managing computer 11 updates information on the configuration of the business system, which is reloaded in the monitoring computer 1 so that the up-to-date information is displayed in each field of the GUI 10.

The example of the screen representation illustrated in FIG. 15 is that which is shown after the AP8 (1011) of the business operation 4 (1001) in FIG. 13 is copied. To be more specific, the AP8 (1011) in the Web system 1010 is copied together with the prerequisite program AP 7 (1012) from the computer 8 (1042) to another computer 4 (1044) in which is deployed another Web system or Web system 2 (1015) comprising a business program APS (1016) and a prerequisite program AP7 (1017) which operate in a manner coordinated with the AP system 1020.

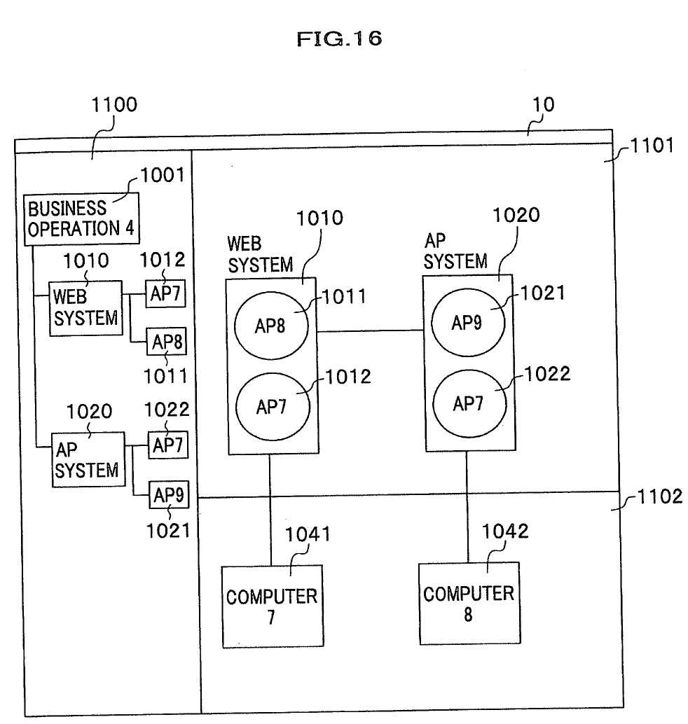

FIG. 16 is a diagram showing an example of the screen representation of configuration of the business system after a business program has been deleted according to an exemplary embodiment of the present invention.

When a request is received from a user or a request event takes place to delete a business program, the managing computer 11 in the program deployment system S according to the present embodiment creates and executes a deleting script for deleting the given business program. Thereafter the managing computer 11 updates information on the configuration of the business system, which is reloaded in the monitoring computer 1 so that the up-to-date information is displayed in each field of the GUI 10.

The example of the screen representation illustrated in FIG. 16 is that which is shown after the AP10 (1030) of the business operation 4 (1001) in FIG. 13 is deleted. To be more specific, the AP10 (1030) is deleted from the computer 9 (1043). Accordingly, the computer 9 (1043) in which the program AP10 (1030) was deployed before the deleting operation, is deallocated.

FIG. 17 is a flowchart showing a process of selecting a destination (target) computer, to which a business program will be moved or copied, when a request is received from a user or a request event takes place to move or copy a business program, in an exemplary embodiment of the present invention.

Specifically, in the managing computer 11, the CPU 2721 loads the program deployment program 6 stored in the storage device 2723 onto the memory 2722, to execute the processes as illustrated in FIG. 17 as follows. It is to be understood that any processes of the managing computer 11 described hereafter and illustrated in the other drawing figures may be implemented in a similar way.

It is assumed in the following discussion that there are provided a plurality of business programs each of which is compatible with more than one operating system.

First in step 1401 the name of at least one target OS 304 on which an installation image of the business program specified by the copying or moving request is deployable is retrieved in the program library management table 21.

In step 1402, information recorded in the business configuration information management table 102 on the names of computers being used by the business program and information recorded in the physical configuration information management table 104 on the names of all the computers are compared, to obtain the names of the computers that are not being used (hereinafter referred to as unassigned computers). Then, it is determined whether or not any unassigned computers in which the same OS as that of which the name is retrieved in step 1401 is deployed (i.e., that in which the specified business program is deployable) are available. The OS in which the specified business program is deployable includes, but not limited thereto, an OS on which the business program has been operated before the copying or moving operation, and an OS with which the installation image of the business program is compatible (i.e., recorded as such in the program library management table 21). If it is determined that at least one unassigned computer is found (Yes in step 1402), then the process goes to step 1403, but otherwise (No in step 1402), the process goes to step 1406.

It is determined in step 1403 whether any unassigned computers are available in which the same OS as that on which the specified business program has been operated originally is deployed. If it is determined that such computers are available (Yes in step 1403), then the process goes to step 1405 where one computer having a largest number of prerequisite OS patch files deployed therein is selected among the available unassigned computers in which the same OS as that on which the specified business program has been operated is deployed.

If it is determined that no such computer is available (No in step 1403), then the process goes to step 1404 where one computer having a largest number of prerequisite OS patch files deployed therein is selected among the available computers in which an appropriate OS is deployed which is not the same OS as that on which the specified business program has been operated originally, but one on which the specified business program is deployable.

The computer having a largest number of prerequisite OS patch files deployed therein is selected in this embodiment because the more prerequisite OS patch files already in the computer, the less number of steps will be required for installing additional prerequisite OS patch files.

It is determined in step 1406, by performing a lookup on the OS information management table 103, whether or not any unassigned computers such that the OS deployed therein can be replaced with the target program-deployable OS retrieved in step 1401 are available. If it is determined that such OS-replaceable unassigned computers are available (Yes in step 1406), then the process goes to step 1407, but otherwise (No in step 1406), the process goes to step 1409.

In step 1407, any one of the OS-replaceable unassigned computers is selected to replace the OS deployed therein, and in step 1408, the name of the target program-deployable OS for replacement is recorded (as OS information) in the storage device 2723 (see FIG. 2).

In step 1409, the computer names of the computer used by another business program and the computer names held in the physical configuration information management table 104 are compared, to obtain information on computers being used by any business programs (hereinafter referred to as computers in use), and it is determined whether or not any computers in use having the target program-deployable OS (as retrieved in step 1401) deployed therein are available. If any such computers in use are available (Yes in step 1409), then the process goes to step 1410, and otherwise (No in step 1409), the process goes to step 1413.

It is determined in step 1410 whether any computers in use are available in which the same OS as that on which the specified business program has been operated is deployed. If it is determined that such computers are available (Yes in step 1410), then the process goes to step 1412 where one computer having a largest number of prerequisite OS patch files deployed therein is selected among the available computers in use in which the same OS as that on which the specified business program has been operated is deployed. If it is determined that no such computer is available (No in step 1410), then the process goes to step 1411 where one computer having a largest number of prerequisite OS patch files deployed therein is selected among the available computers in use in which an appropriate OS is deployed which is not the same OS as that on which the specified business program has been operated, but one on which the specified business program is deployable.

In step 1413, it is shown in the GUI 10 that no computer in which the specified business program is deployable is available.

In accordance with the process as discussed above, a computer in which the specified business program is to be deployed can be optimally selected on the basis of information of the specified business program.

FIG. 18 is a diagram showing a to-be-deployed program management table 106 in an exemplary embodiment of the present invention. This table 106 is designed to hold information on programs required to deploy a business program (‘AP8’ as indicated in the business program 1515 is an example of the business program to be deployed) specified in a copying or moving request, and is created by the managing computer 11 using the program operating maximum configuration template 109 (see FIG. 5). The to-be-deployed program management table 106 may be created by copying the information on prerequisite programs required to deploy a business program to the program operating maximum configuration template 109. The information on the program may include information on the program level.

The name of an OS to be deployed in the target computer is input into a field for the OS 1511 assigned to program level ‘1’. The names of OS patches (prerequisite OS patch files) prerequisite for the specified business program and programs prerequisite therefor are input into fields for the OS patch 1512 assigned to program level ‘2’. Into fields for the business program 1515, business program patch 1516, prerequisite program 1513 and prerequisite program patch 1514 assigned to program level ‘3’, the name of a specified business program, the names of patch files for the specified business program, the names of prerequisite programs which are prerequisite for the specified business program or the other prerequisite programs, and the names of patch files for the prerequisite programs input in the fields denoted by 1513 are input respectively. Hereupon, it is understood that each program name is input automatically by the managing computer 11 in this exemplary embodiment; a detailed description will be given later with reference to FIG. 20.

In other words, it is shown that in order to deploy a business program identified by the program name ‘AP8’, programs other than ‘AP8’, such as ‘OS1’, ‘Patch11’, ‘Patch12’, ‘AP7’ and ‘AP7Patch1’, are required, and the programs thus required are listed in the to-be-deployed program management table 106.

It is to be understood that each allocated field of information on programs corresponding to the maximum configuration templates may or may not be filled in with the program name, depending upon the specified business program.

FIG. 19 is a diagram showing a program configuration difference information management table 105 in an exemplary embodiment of the present invention. This table 105 is designed to hold information on differences between physical configuration of the computer to which the specified business program is deployed (as retrieved from the physical configuration information management table 104) and post-modification configuration recorded in the to-be-deployed program management table 106, which information is specified for each program (shown in the fields of program name 1603) arranged in program levels (shown in the fields of program level 1601). Denoted in the fields of difference type 1602 of the program configuration difference information management table 105 is information on the difference type, which includes: (1) a program existing only in the computer to which the program is to be deployed, as represented by ‘−’; (2) a program existing only in the to-be-deployed program management table 106, as represented by ‘+’; and (3) a program that is not subjected to modification, as represented by ‘ ’ (blank). The name of the target to-be-deployed program is recorded in the field of program name 1603. In an exemplary embodiment, this table 105 is created by the managing computer 11. This table 105 may be displayed in the GUI 10 of the monitoring computer 1, or presented to a user by means of other devices having a display function.

FIG. 20 is a flowchart showing a process of determining a program configuration difference in an exemplary embodiment of the present invention, in which the managing computer 11 first creates a to-be-deployed program management table 106 and then creates a program configuration difference information management table 105 using information retrieved from the to-be-deployed program management table 106 and the physical configuration information management table 104.

The managing computer 11 determines in step 1701 whether or not an OS in the target computer is to be replaced (the preceding process in FIG. 17 has involved step 1408), and if the OS is to be replaced (Yes in step 1701), then the process goes to step 1703 where the name of the OS determined in step 1408 is input automatically into the ‘program name’ field for OS 1511 of the to-be-deployed program management table 106 (see FIG. 18). If the OS is not to be replaced (No in step 1701), then the process goes to step 1702 where the name of the OS deployed in the target computer is input automatically into the ‘program name’ field for OS 1511.

In step 1704, the managing computer 11 retrieves information on the specified business program compatible with the OS corresponding to the OS name input in the field for OS 1511, by performing a lookup on the program configuration management table 101, and automatically inputs each item of information on the prerequisite OS patch name 803 and prerequisite program name 804 for the specified business program into corresponding ‘program name’ fields (i.e., for OS patch 1512 and prerequisite program 1513) of the to-be-deployed program management table 106.

In step 1705, the managing computer 11 performs a lookup on the program library management table 21 (see FIG. 6), to thereby determine whether or not the OS 1511 compliant patch files 1516, 1514 for the specified business program 1515 and for the prerequisite program 1513 are stored availably, and if such patch files are located therein (Yes in step 1705), then the process goes to step 1706 where each item of information as located on program name 303 of the patch files are input automatically into the corresponding ‘program name’ fields (i.e., for business program patch 1516 and prerequisite program patch 1514) of the to-be-deployed program management table 106 to complete the to-be-deployed program management table 106. If such patch files are not located in the program library management table 21 (No in step 1705), the process goes to step 1707.

Next, in step 1707, the managing computer 11 compares information recorded in the to-be-deployed program management table 106 and information recorded in the physical configuration information management table 104, on the target computer to which the specified business program is to be deployed, for each program level, and determines whether or not there exist one or more program levels having any program(s) to which the difference type is to be set in the program configuration difference information management table 105 (see FIG. 19). If such program levels exist (Yes in step 1707), then the process goes to step 1708, and if the difference types have been set to the programs in all the program levels (No in step 1707), then the process is terminated.

In step 1708, the managing computer 11 selects one of the program levels having program(s) to which the difference type is to be set, and proceeds to perform step 1709.

In step 1709, the managing computer 11 inputs the program names and difference type ‘−’ of the programs in the selected program level into the program configuration difference information management table 105, which programs exist only in the target computer and thus the program names thereof are recorded only in the physical configuration information management table 104 but not in the to-be-deployed program management table 106), whereas the managing computer 11 inputs the program names and difference type ‘+’ of the programs in the selected program level into the program configuration difference information management table 105, which programs exist only in the to-be-deployed program management table 106 but not in the physical configuration information management table 104). If there exist programs in the selected program level which are recorded in both of the physical configuration information management table 104 and the to-be-deployed program management table 106, the managing computer 11 inputs only the program names 1603 of those programs with the fields for the difference type 1602 left blank into the program configuration difference information management table 105. Thereafter, the process goes back to step 1707.

FIG. 21 is a diagram showing an example of a script component used to deploy a business program. The script component 1800 includes items of an executive computer name 1801 and items of an executive script. The executive script 1802 is a script which is forwarded to and executed in the agent processing unit 30 of the business computer 4 corresponding to the executive computer name 1801.

Those items may contain parameters provided in the program deployment system S. The parameters refer to addresses indicative of elements of a data model defined in the data model 108 that will be described later. The parameters are expressed in a series of characters sandwiched between ‘$’ and ‘$’ and composed of element names, such as business operation name 2401, with a mark ‘.’ (period) interposed between adjacent element names, for representing the names of linked elements of a specified data model (an example of the structure and elements of a data model will be described later with reference to FIG. 34).

A value which can be obtained through parameters is the value stored in the parameter of the last element traced in sequence of the data model (e.g., the parameter of ‘operating computer name’ for executive computer name 1801 in the example illustrated in FIG. 21). The use of parameters in a script component 1800 as described above enables the managing computer 1I1 to obtain a necessary value in a script component, even when the business system configuration is modified, from the data model in which an up-to-date value is stored, and to execute a script composed of the script component without changing definition in the script component.

When parameters are utilized for the executive computer name 1801, the parameter for specifying a computer name is necessary.

When parameters are utilized in the script component for deployment 403 (see FIG. 7), the parameter for specifying a program library ID 301 corresponding to a disk image to be deployed is necessary.

Thus, pertinent values are input (stored) into the necessary parameters to thereby enable the script component to compose an appropriate executable script.

FIG. 22 is a diagram showing an example of a script template 1900 for deploying a disk image of an OS manageably recorded in the program library management table 21 (see FIG. 6). This template 1900 is representative of a template for program level 1.

The template 1900 is stored in the database of the script templates 24 as shown in FIG. 1, and comprises an OS deploying script component 1901, an OS configuration setting script component 1903, an agent processing unit configuration setting script component 1905, and linking script components 1902. The OS deploying script component 1901 includes a set of instructions for deploying a disk image of an OS. The OS configuration setting script component 1903 includes a set of instructions for setting configuration of the OS deployed. The agent processing unit configuration setting script component 1905 is a set of instructions for setting configuration of the agent processing unit 30 and for starting up the agent processing unit 30. The linking script components 1902 are designed to link the other script components together.

Denoted by arrows in FIG. 22 is an execution sequence of the script components, which shows that the process is designed to run the script components in the order of 1901, 1902, 1903, 1902, 1905 and 1902. In an exemplary embodiment, the script component for deployment 403 and the script component for configuration 405 as shown in the script library management table 23 (see FIG. 7) may be used (copied) for the OS deploying script component 1901 and the OS configuration setting script component 1903, respectively.

The linking script components 1902 are script components which may have a reboot flag field as a reboot indicator for determining whether or not to reboot the target computer, and which are under control of the program deployment system S in the present embodiment and thus do not require manual definition by a user.

An agent processing unit 30 is deployed to the target business computer 4 together when a disk-copy operation for an OS is performed, and then, the agent processing unit configuration setting script component 1905 is executed to automatically start up the agent processing unit 30 after setting configuration thereof, without requiring manual definition by a user.

It is appreciated that the script template 1900 as shown in FIG. 22 provides a list of script components to be incorporated into a script, but the script components has not yet been copied therein in actuality. The same goes for the script template shown in FIGS. 23-26.

FIG. 23 is a diagram showing an example of a script template 1910 for deploying an installation image of OS patches manageably recorded in the program library management table 21 (see FIG. 6). This template 1910 is representative of a template for program level 2.

The template 1910 is stored in the database of the script templates 24 as shown in FIG. 1, and comprises an OS patch deploying script component 1911, and a linking script component 1902. The OS patch deploying script component 1911 includes a set of instructions for deploying a disk image of OS patches, and the linking script component 1902 are designed to link the other script components together. The execution sequence of the script components are shown in the order of 1911 to 1902. In an exemplary embodiment, the script component for deployment 403 as shown in the script library management table 23 (see FIG. 7) may be used (copied) for the OS patch deploying script component 1911.

FIG. 24 is a diagram showing an example of a script template 1920 for deploying an installation image of a business program manageably recorded in the program library management table 21 (see FIG. 6). This template 1920 is representative of a template for program level 3.

The template 1920 is stored in the database of the script templates 24 as shown in FIG. 1, and comprises a program deploying script component 1921, a program configuration setting script component 1923, a coordinated program configuration setting script component 1925, a program starting script component 1927, and linking script components 1902. The program deploying script component 1921 includes a set of instructions for deploying a disk image of a business program. The program configuration setting script component 1923 includes a set of instructions for setting configuration of the business program deployed. The coordinated program configuration setting script component 1925 includes a set of instructions for setting configuration of coordinated programs which operates together with the business program deployed. The program starting script component 1927 includes a set of instructions for starting up the program(s) deployed. The linking script components 1902 are designed to link the other script components together. The execution sequence of the script components are shown in the order of 1921, 1902, 1923, 1902, 1925, 1902, 1927 and 1902.

In an exemplary embodiment, the script component for deployment 403, the script component for configuration 405, the script component for coordinated program setting 406 and the script component for program startup 408 as shown in the script library management table 23 (see FIG. 7) may be used (copied) for the program deploying script component 1921, the program configuration setting script component 1923, the coordinated program configuration setting script component 1925 and the program starting script component 1927, respectively.

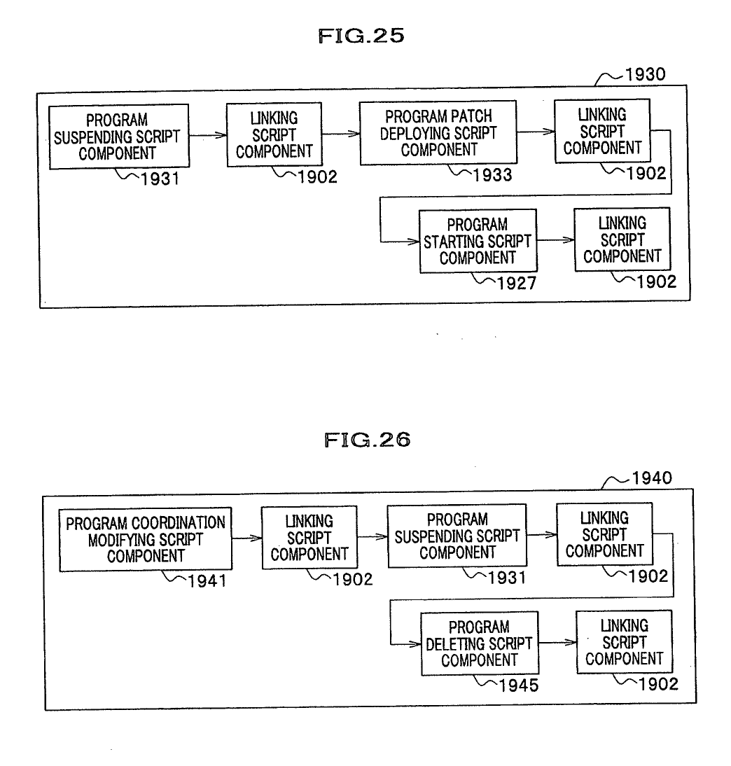

FIG. 25 is a diagram showing an example of a script template 1930 for deploying program patches for a business program manageably recorded in the program library management table 21 (see FIG. 6). This template 1930 is representative of a template for program level 3.

The template 1930 is stored in the database of the script templates 24 as shown in FIG. 1, and comprises a program suspending script component 19931, a program patch deploying script component 1933, a program starting script component 1927, and linking script components 1902. The program suspending script component 1931 includes a set of instructions for suspending a patch applying program. The program patch deploying script component 1933 includes a set of instructions for deploying program patches. The program starting script component 1927 includes a set of instructions for starting up the program(s) deployed. The linking script components 1902 are designed to link the other script components together. The execution sequence of the script components are shown in the order of 1931, 1902, 1933, 1902, 1927 and 1902.

In an exemplary embodiment, the script component for program suspension 409, the script component for deployment 403, and the script component for program startup 408 as shown in the script library management table 23 (see FIG. 7) may be used (copied) for the program suspending script component 1931, the program patch deploying script component 1933 and the program starting script component 1927, respectively.

FIG. 26 is a diagram showing an example of a script template 1940 for deleting a business program. This template 1940 is representative of a template for program level 3.

The template 1940 is stored in the database of the script templates 24 as shown in FIG. 1, and comprises a program coordination modifying script component 1941, a program suspending script component 1931, a program deleting script component 1945 and linking script components 1902. The program coordination modifying script component 1941 includes a set of instructions for modifying (canceling) coordination of a program coordinated with a target program to be deleted. The program suspending script component 1931 includes a set of instructions for suspending the target program to be deleted. The program deleting script component 1945 includes a set of instructions for deleting the target program. The linking script components are designed to link the other script components together. The execution sequence of the script components are shown in the order of 1941, 1902, 1931, 1902, 1945 and 1902.

In an exemplary embodiment, the script component for program coordination modification 407, the script component for program suspension 409, and the script component for deletion 404 as shown in the script library management table 23 (see FIG. 7) may be used (copied) for the program coordination modifying script component 1941, the program suspending script component 1931, the program deleting script component 1945, respectively.

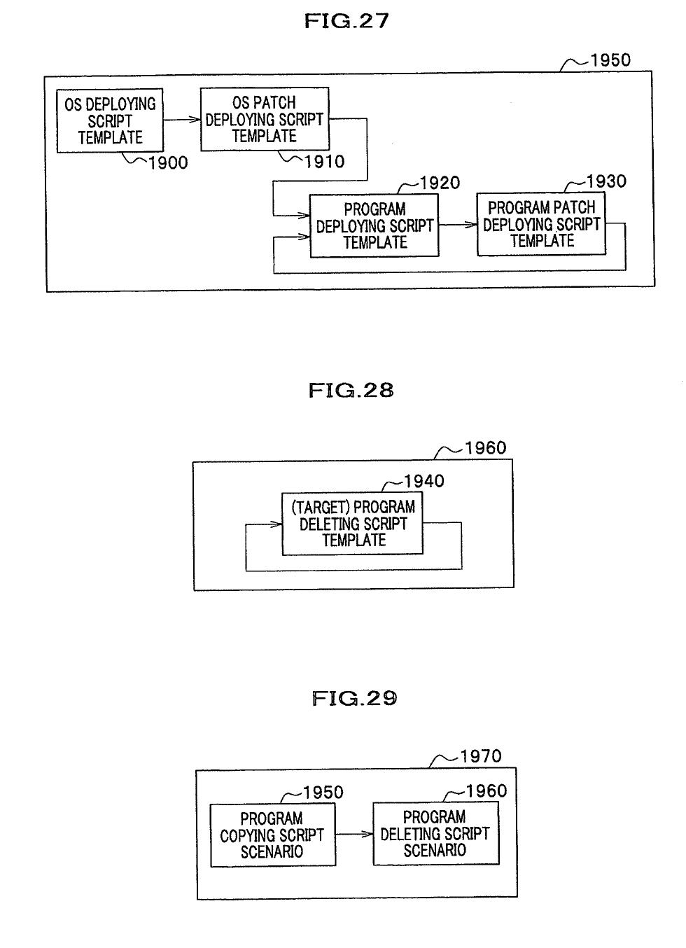

FIG. 27 is a diagram showing an example of a program copying script scenario 1950 that is a combination of script templates required to copy a business program.

This scenario 1950 is stored in the database of the script templates 24 as shown in FIG. 1, and comprises a plurality of script templates used to copy a business program. The script templates making up the scenario 1950 include an OS deploying script template 1900 (see FIG. 22), an OS patch deploying script template 1910 (see FIG. 23), a program deploying script template 1920 (see FIG. 24), and a program patch deploying script template 1930 (see FIG. 25) which are to be executed in this order.

In operation, the principal template for copying a target business program is the program deploying script template 1920, and the other three script templates 1900, 1910 and 1930 serves to perform adjunctive functions.

In instances where at least one prerequisite program is to be deployed, after the program patch deploying script template 1930 is executed for deployment of the specified business program, the program deploying script template 1920 and the program patch deploying script template 1930 are executed repeatedly a necessary number of times (the number corresponding to the number of the at least one prerequisite program), to deploy the prerequisite program(s).

FIG. 28 is a diagram showing an example of a program deleting script scenario 1960 that is a combination of script templates required to delete a business program.

This scenario 1960 is stored in the database of the script templates 24 as shown in FIG. 1, and comprises a program deleting script template 1940 used to delete a specified (target) business program. The program deleting script template 1940 is a script template executed to delete a business program.

In instances where at least one prerequisite program is deployed for a specified business program to be deleted and the prerequisite program(s) is not used in the other business program or the like, deletion of the specified business program renders the prerequisite program being not used unnecessary, and thus the program deleting script template 1940 is executed repeatedly a necessary number of times (corresponding to the number of the prerequisite program(s) being not used) to delete the prerequisite program(s).

FIG. 29 is a diagram showing an example of a program moving script scenario 1970 that is a combination of script templates required to move a business program.

This scenario 1970 is stored in the database of the script templates 24 as shown in FIG. 1, and comprises a program copying script scenario 1950 and a program deleting script scenario 1960 which are executed in this order to move a business program.

FIG. 30 is a flowchart showing an exemplary process of creating a copying script, which process is executed in step 908 (see FIG. 12) in response to a request to copy a business program. In the event, the managing computer 11 executes the following process.

First, in step 2001, a program copying script scenario 1950 (see FIG. 27), which will be used as a model or prototype pattern, is obtained from among the script templates 24, so that adequate script components may be subsequently set into corresponding items of the script scenario 1950.

In step 2002, the program configuration difference information management table 105 (see FIG. 19), which has already been created in advance, is investigated to determine whether or not the ‘difference type’ field of program level ‘1’ contains ‘+’ indicative of addition of an OS. If ‘+’ is found therein (Yes in step 2002), then the process goes to step 2003, but otherwise (No in step 2002), the process goes to step 2010.

In step 2003, the program library management table 21 (see FIG. 6) is searched on the basis of the OS name in the ‘program name’ field, which is another field of program level ‘1’ of which the ‘difference type’ field is ‘+’ in the program configuration difference information management table 105, to retrieve information on the program library ID 301 and the reboot flag 305 for the target OS 304 corresponding to the OS name, from the program library management table 21.

Further, script components corresponding to the retrieved information on the program library ID 301 are obtained from the script library management table 23. The obtained script components are copied for the corresponding script components (i.e., OS deploying script component 1901 and OS configuration setting script component 1903) defined in the OS deploying script template 1900 (see FIG. 22) of the program copying script scenario 1950 (see FIG. 27). In addition, the retrieved program library ID is set into the OS deploying script component 1901.

Next, in step 2004, the information on the reboot flag retrieved in step 2003 is set into the linking script component 1902 immediately following the OS deploying script component 1901 (see FIG. 22), and the process goes to step 2013.

In step 2013, configuration information is collected from the agent processing unit 30 of the business computer from which the business program is to be copied, and the configuration information is copied into the agent processing unit configuration setting script component 1905. Thereafter, the process goes to step 2005.

In step 2010, since no OS is to be deployed, the OS deploying script template 1900 is deleted from the program copying script scenario 1950 (see FIG. 27), and the process goes to step 2005.

In this way, some of constituent script templates can be deleted automatically from the program copying script scenario 1950 on an as-needed basis.

In step 2005, the program configuration difference information management table 105 is investigated to determine whether or not the ‘difference type’ field of program level ‘2’ contains ‘+’. If ‘+’ is found therein (Yes in step 2005), then the process goes to step 2006, but otherwise (No in step 2005), the process goes to step 2011.

In step 2006, the program library management table 21 (see FIG. 6) is searched on the basis of the OS patch name in the ‘program name’ field, which is another field of program level ‘2’ of which the ‘difference type’ field is ‘+’ in the program configuration difference information management table 105 (see FIG. 19), to retrieve the program library IDs and the reboot flags for the target OS patches corresponding to the OS patch name, from the program library management table 21.

Further, script components corresponding to the retrieved program library IDs are obtained from the script library management table 23 (see FIG. 7). The obtained script components are copied for the corresponding script components (i.e., OS patch deploying script component 1911) defined in the OS patch deploying script component 1910 (see FIG. 23) of the program copying script scenario 1950 (see FIG. 27). In addition, the retrieved program library IDs are set into the OS patch deploying script component 1910.

In step 2007, information on the reboot flags retrieved in step 2006 is copied into the linking script component 1902 immediately following the OS patch deploying script component 1911 (see FIG. 23).

In step 2011, since no OS patch is to be deployed, the OS patch deploying script template 1910 is deleted from the program copying script scenario 1950 (see FIG. 27), and the process goes to step 2008.

Next, in step 2008, the program configuration difference information management table 105 (see FIG. 19) is investigated to determine whether or not the ‘difference type’ field of program level ‘3’ contains ‘+’. If ‘+’ is found therein (Yes in step 2008), then the process goes to step 2009, but otherwise (No in step 2008), the process goes to step 2012.

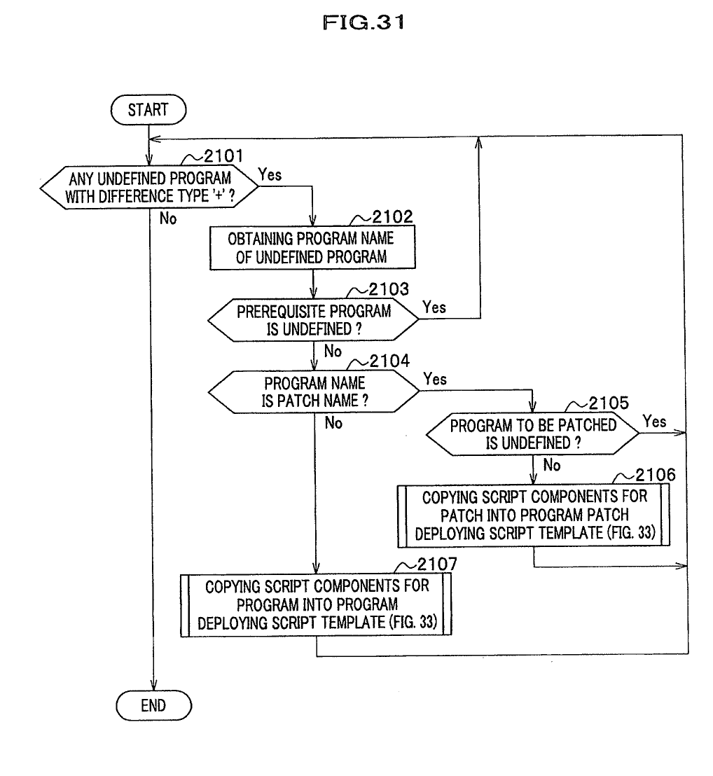

In step 2009, a process of establishing a program deploying script template as illustrated in FIG. 31 is executed.

In step 2012, since no program is to be deployed, the program deploying script template 1920 and the program patch deploying script template 1930 are deleted from the program copying script scenario 1950 (see FIG. 27).

As described above, script templates may be added to or deleted from the script scenario on an as-needed basis, and scripts generated by copying script components are stored in the database of the scripts 25.

FIG. 31 is a flowchart showing an exemplary process of establishing a program deploying script template, which process is executed in step 2009 of FIG. 30. In step 2101, the program configuration difference information management table 105 (see FIG. 19) is investigated to determine whether or not any undefined programs of program level ‘3’, of which ‘difference type’ field contains ‘+’, are found in the program configuration difference information management table 105 (see FIG. 19). If at least one of such undefined programs is found (Yes in step 2101), then the process goes to step 2102 but otherwise (No in step 2102), the process is terminated.

In step 2102, the program name of an undefined program with difference type ‘+’ is obtained in the program configuration difference information management table 105.

Next, it is determined in step 2103 whether or not any prerequisite programs for the program having the program name obtained in step 2102 are undefined. If at least one of such undefined prerequisite programs is found (Yes in step 2103), then the process goes to step 2101, while if the prerequisite programs are all defined (No in step 2103), the process proceeds to step 2104.

It is determined in step 2104 whether or not the program name is a patch name. If it is a patch name (Yes in step 2104), then the process goes to step 2105, but otherwise (No in step 2104), the process goes to step 2107.

It is determined in step 2105 whether or not a program to be patched with the patch file identified by the patch name is undefined. If the program is undefined (Yes in step 2105), then the process goes to step 2101, while if the program has already been defined (No in step 2105), the process proceeds to step 2106.

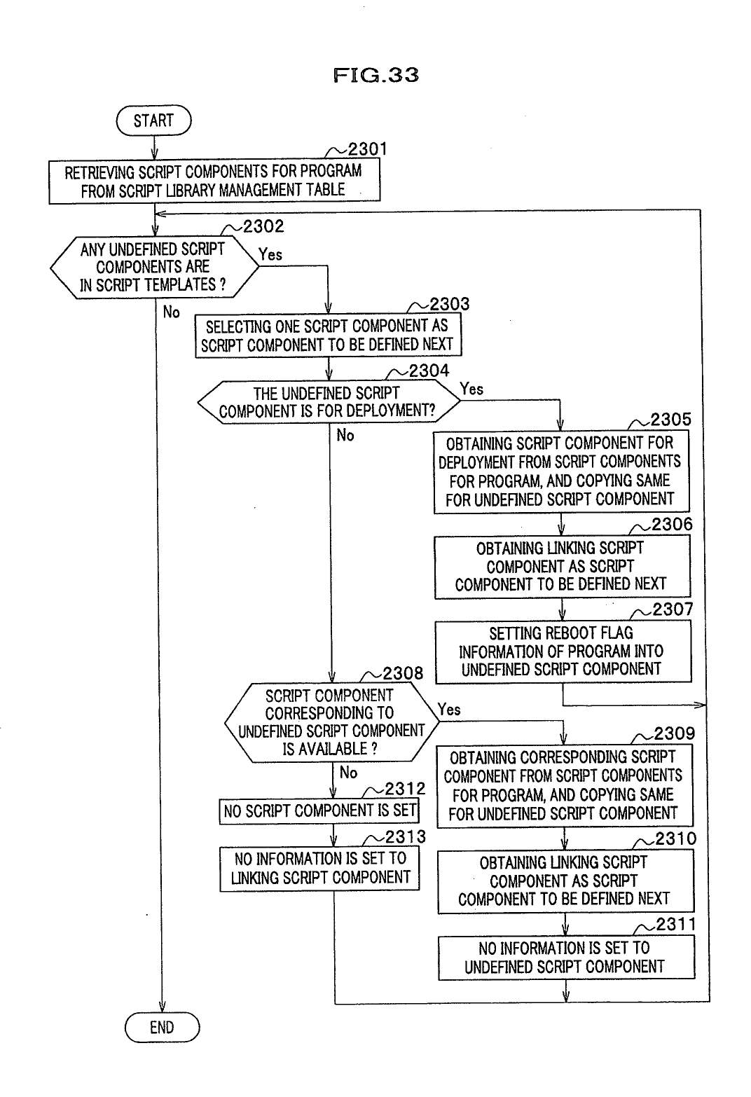

In step 2106, script components for the target program patch are copied for use in the program patch deploying script template 1930 (see FIG. 25). A detailed description of the process in step 2106 for copying the script components for the relevant programs into the script template will be given later with reference to FIG. 33. Subsequently, the process goes back to step 2101.

In step 2107, script components for the target program are copied for use in the program deploying script template 1920 (see FIG. 24). If there is another program deploying script template 1920 that has already been established, a newly established program deploying script template 1920 is linked to the last template of the old template 1920, and the script components are copied into the new template 20.

A detailed description of the process in step 2107 for copying the script components for the relevant programs into the script template will be given later with reference to FIG. 33.

Subsequently, the process goes back to step 2101.

FIG. 32 is a flowchart showing an exemplary process of creating a program deleting script, which process is executed in step 911 (see FIG. 12) in response to a request to delete a business program.

In step 2201, a program deleting script scenario 1960 (see FIG. 28) used as a model for making a script for deletion is obtained, so that necessary script components will thereafter be set into relevant locations (copied into the corresponding templates) in the script scenario 1960 as necessary items thereof.

First, in step 2202, script components for the target programs to be deleted are copied into the program deleting script template 1940 (see FIG. 26), and then the process proceeds to step 2203. A detailed description of the process in step 2202 for copying the script components for the relevant programs into the script template will be given later with reference to FIG. 33.

In step 2203, the program name of the program for which the script components are copied into the template 1940 is recorded as defined program. Thereafter, the process proceeds to step 2204.

In step 2204, the program configuration management table 101 is investigated to determine (obtain information as to) whether or not there are any programs prerequisite for the defined program, and if at least one of such prerequisite programs is found (Yes in step 2204), then the process goes to step 2205, but otherwise (No in step 2204), the process is terminated.

In step 2205, a new program deleting script template 1940 (see FIG. 26) is added to the last template, and the script components for the corresponding prerequisite program name are copied for use in the newly added template 1940 (as described above with reference to FIG. 33). Thereafter, the process goes back to step 2203.

The resulting script for deletion created by copying script components into a script template in the program deleting script scenario is stored in the database of scripts 25.

FIG. 33 is a flowchart showing an exemplary process of copying script components for a relevant program into a script template.

In step 2301, the program library management table 21 (see FIG. 6) is searched on the basis of the ‘program name’ of the target program and the target OS on which the target program is deployed or deleted, to retrieve information on the program library ID 301 and the reboot flag 305 for the target program from the program library management table 21. In addition, the script library management table 23 (see FIG. 7) is searched on the basis of the retrieved information on the program library ID, to obtain script components for use in the target program from the script library management table 23.

It is determined in step 2302 whether or not any undefined script component is found in the script template, and if at least one of such undefined script components is found (Yes in step 2302), then the process goes to step 2303, but otherwise (No in step 2302), the process is terminated.

In step 2303, one of the undefined script components is selected, as the undefined script component to be defined next, from the script template.

Next, it is determined in step 2304 whether or not the selected undefined script component is a script component for deployment, and if it is a script component for deployment (Yes in step 2304), then the process goes to step 2305, but otherwise (No in step 2304), the process goes to step 2308.

In step 2305 the script component for deployment is obtained from the script components for the program, and copied for the undefined script component. Also in step 2305, the program library ID obtained in step 2301 is set into the copied script component for deployment. The process then proceeds to step 2306.

In step 2306, a linking script component that is the next undefined script component is obtained from the template. In step 2307, information on the reboot flag of the program is obtained from the program library management table 21, and set into the linking script component. Thereafter, the process goes back to step 2302.

It is determined in step 2308 whether or not a script component corresponding to the undefined script component is available; if such a corresponding script component is available (Yes in step 2308), then the process goes to step 2309, but otherwise (No in step 2308), the process goes to step 2312.

Next, in step 2309, the script component corresponding to the undefined script component is obtained and copied for the undefined script component in the template, and the process goes to step 2310.

In step 2310, a linking script component that is the next undefined script component is obtained, while in step 2311, no information is set to the obtained script component. Optionally, in step 2311, the linking script component that is the undefined script component may be deleted. Thereafter, the process goes back to step 2302.

In step 2312, since no script component corresponding to the undefined script component is available, no script component is set. Optionally, in step 2312, the undefined script component may be deleted.

Similarly, in step 2313, a linking script component that is the next undefined script component is obtained, but no information is set to the obtained script component. Optionally, in step 2313, the linking script component that is the undefined script component may be deleted. Thereafter the process goes back to step 2302.

FIG. 34 is a diagram showing an example of a data model template 107 for parameters. The data model template 107 is indicative of a data structure of parameters for use in a script component. This template 107 is utilized to generate a data model for each business program.

In the data model template 107, a business program name 2402 is linked with a business operation name 2401 and a group name 2414. The business operation name 2401 is the name of a business operation to which a business program with the business program name 2401 pertains. It is to be understood that the group name 2414 may be omitted (i.e., the business program name 2402 is not necessarily linked with the group name 2414).

The business program name 2402 is further linked with an operating computer name 2403, a prerequisite OS patch name 2404, a prerequisite program name 2405, a related program name 2406 and a destination computer name 2407. It is to be understood that the prerequisite OS name 2404, the prerequisite program name 2405 and/or the related program name 2406 may be omitted, and the data model for the business program to be deleted has no link with the destination computer name 2407.

Linked with the operating computer name 2403 are an OS name 2408, an OS patch 2409 and a business program name 2410. It is to be understood that the OS patch 2409 and the business program name 2410 may be omitted.

The data model having a data structure as described above is, once generated, rendered uniquely identifiable by the business operation name 2401, group name 2414 and business program name 2402 in the program deployment system S.

In the generated data model, the prerequisite program name 2405 and the related program name 2406 are configured to be linkable with a data model of the target program. If the business program requires a prerequisite program, the prerequisite program name 2405 may be linked with the business program name 2402 of a data model of the prerequisite program. Similarly, if the business program is associated to a related program, the related program name 2406 is liked with the business program name 2402 of a data model of the business program.

In some instances, one business operation may have a plurality of the same business programs operating on different computers required to realize the business operation; therefore, the data model of a prerequisite program has the same business operation name 2401 and the same group name 2414, and the business program name 2402 thereof (of the prerequisite program) coincides with the prerequisite program name. The data model of a related program has the same business operation name 2401, and the business program name 2402 thereof (of the related program) coincides with the related program name.

As described above, in one embodiment, a data model generated for each business program is linked with the data models corresponding to the prerequisite programs and related programs of the data model, so that data on the programs associated with the business program can be obtained as parameters to be assigned to the variables in the script components. For example, when an executive script 1802 (see FIG. 21) is to be executed on a computer on which programs related to a business program are operated, the parameters for the executive computer name 1801 may be defined as “$business_operation_name.group_name.program_name.related_program_name.operating_computer_name$”.

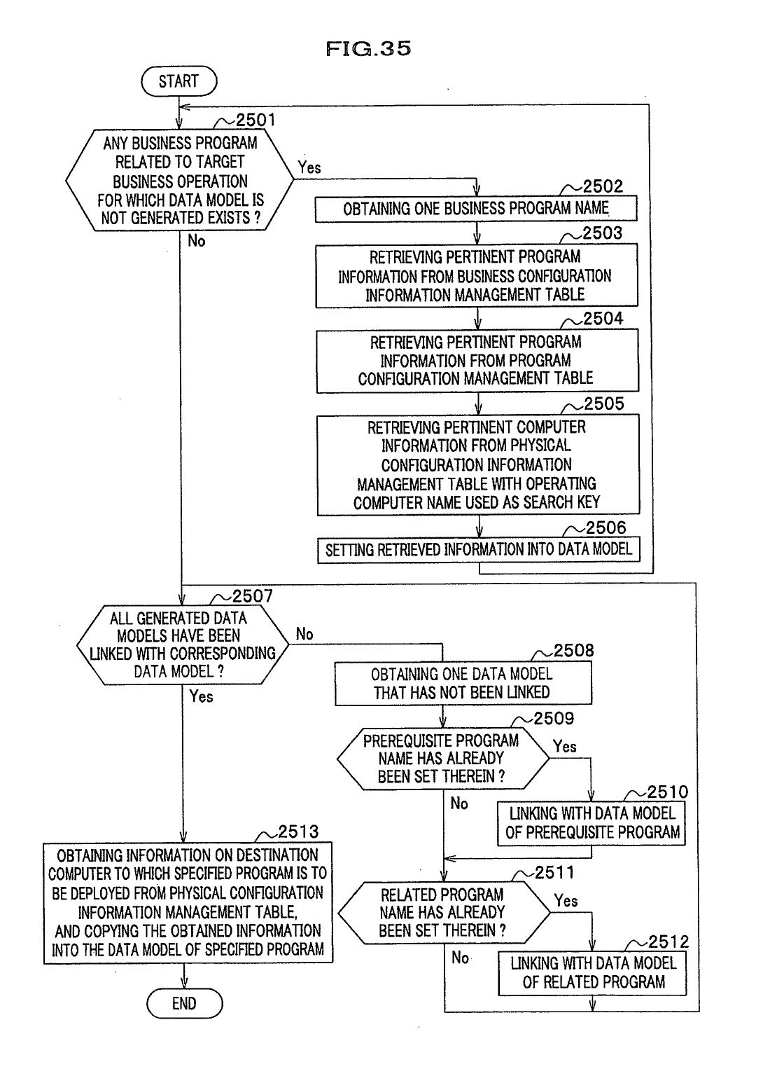

FIG. 35 is a flowchart showing an exemplary process of generating a data model 108, which process is achieved by copying data of a business program into a data model template 107. The data model is generated for each business program by the managing computer 11 utilizing information on all the business programs related to a business operation in which the target business program specified in a request to copy, move or delete is to be operated.

First, it is determined in step 2501 whether or not there exist any business programs related to the target business operation for which a data model is not generated, and if at least one of such business programs is found (Yes in step 2501), then the process goes to step 2502, but otherwise (No in step 2501), the process goes to step 2507.

In step 2502, one business program name of the business programs for which a data model is not generated is obtained. In step 2503, data corresponding to the business program name obtained in step 2502 of the business program related to the target business operation is retrieved from the business configuration information management table 102 (see FIG. 9).

In step 2504, data on the pertinent business program is retrieved from the program configuration management table 101 (see FIG. 11).

In step 2505, an operating computer name is obtained from the business configuration data retrieved in step 2503, and data on the pertinent computer is retrieved from the physical configuration information management table 104 (see FIG. 10).

Thereafter, in step 2506, the pertinent data are copied into a template of the data model. To be more specific, the business system name 601, group name 602, business program name 603 and computer name 604 retrieved from the business configuration information management table 102 (see FIG. 9) are copied into the business operation name 2401, group name 2414, business program name 2402 and operating computer name 2403, respectively.

Further, the prerequisite OS patch name 803, prerequisite program name 804 and coordinated program name 805 retrieved from the program configuration management table 101 are copied into the prerequisite OS patch name 2404, prerequisite program name 2405 and related program name 2406, respectively. Next, the OS 703, OS patch 704 and business program 705 of the computer retrieved from the physical configuration information management table 104 are copied into the OS name 2408, 2411, OS patch name 2409, 2412, business program name 2410, 2413, respectively.

The data are copied into the template as described above, to thereby complete the data model of the business program. If data does not correspond to any items in the template, the operation of copying the data is skipped, and optionally the template may be deleted.

Next, the generated data model for the business program is linked with data models corresponding to the prerequisite program name and the coordinated program name thereof. It is first determined in step 2507 whether or not all the generated data models have been linked with the corresponding data models, and if so (Yes in step 2507), the process goes to step 2513, but otherwise (No in step 2507), the process goes to step 2508.

In step 2508, one of the data models that have not been linked yet is obtained.

It is determined in step 2509 whether or not a prerequisite program name has been set in the obtained data model. If the prerequisite program name has already been set therein (Yes in step 2509), then the process goes to step 2510, but otherwise (No in step 2509), the process goes to step 2511.

In step 2510, a data model having a corresponding prerequisite program name with the same business operation name and the same group name is obtained, and the business program name 2402 of the obtained data model is linked with the prerequisite program name 2405; then, the process goes to step 2511.

It is determined in step 2511 whether or not a related program name has been set in the obtained data model. If the related program name has already been set therein (Yes in step 2511), then the process goes to step 2512, but otherwise (No in step 2512), the process goes back to step 2507.

In step 2512, a data model having a corresponding prerequisite program name with the same business operation name is obtained, and the business program name 2402 of the obtained data model is linked with the related program name 2406; then, the process goes to step 2507.

In step 2513, since a destination computer is selected in the data model of the business program specified in a copying or moving request, data on the selected destination computer is obtained from the physical configuration information management table 104, and data of the destination computer name 2407, OS name 2411, OS patch name 2412, and business program name 2413 are copied into the data model of the specified business program.

FIG. 36 is a flowchart showing an exemplary process of executing a copying, moving or deleting script 25 as created. The script 25 is created from a script scenario selected in accordance with a request, which script scenario is completed by adding script templates thereto and/or deleting script templates therefrom, and copying corresponding script components into the script templates thereof. The script 25 is executed by executing the copied script components one by one from the first component of the script.

It is determined in step 2601 whether or not any script components to be executed remains in the script. If at least one of such script components is found (Yes in step 2601), then the process goes to step 2602, but otherwise (No in step 2601), the process of executing the script is terminated.

In step 2602, one script component to be executed next is obtained. Next, it is determined in step 2603 whether or not the obtained script component is a linking script component. If it is a linking component (Yes in step 2603), then the process goes to step 2604, but otherwise (No in step 2603), the process goes to step 2608.

In step 2604, the reboot flag information set in the linking script component is checked, and it is determined whether or not the reboot flag is ON. If the reboot flag is ON (Yes in step 2604), then the process goes to step 2605, while if the reboot flag is OFF or null (No in step 2604), the process goes to step 2612.

In step 2605, a computer on which the script components preceding the linking script component have been executed is rebooted. To be more specific, a reboot request is transmitted to the agent processing unit 30 of the computer, and the process proceeds to step 2606.

In step 2606, the process waits until a reboot process completion notification is received from the agent processing unit 30 of the computer on which the script components have been executed. Upon receipt of the reboot process completion notification, the process goes back to step 2601.

It is determined in step 2612 whether or not a reboot request has been transmitted to the agent processing unit 30 of the computer on which the script components preceding the linking script component have been executed. If the reboot request has been transmitted (Yes in step 2612), the process goes to step 2605, but otherwise (No in step 2612), the process goes to step 2607.

In step 2607, a query is run to the agent processing unit 30 of the computer on which the script components preceding the linking script component have been executed to check whether or not the computer is in the process of rebooting. If the computer automatically started rebooting and has not finished the reboot process yet (Yes in step 2607), the process goes to step 2606 where the process waits for receiving the reboot process completion notification from the agent processing unit 30. If the computer has already finished the reboot process (No in step 2607), the process goes to step 2601.

If it is determined in step 2603 that the script component to be executed next as obtained in step 2602 is not a linking script component (No in step 2603), the process goes to step 2608 where it is determined whether or not the script component is an undefined script component. If it is not an undefined script component (No in step 2608), the process goes to step 2609, while if it is an undefined script component (Yes in step 2608), the process goes back to step 2601.

In step 2609, the executive computer name 1801 (see FIG. 21) that is the name of a computer on which the script component is to be executed, and data specified with parameters used in the executive script 1802 are obtained from the data models 108 (see FIG. 4 and FIG. 34) and substituted for the variables as parameters.

Next, in step 2610, the executive script 1802 is transferred to the agent processing unit 30 of the computer identified by the executive computer name 1801.

Subsequently, in step 2611, the process waits until an execution result of the executive script 1802 is received from the agent processing unit 30, and upon receipt, the process goes back to step 2601.

As described above, according to the program deployment system S of the present embodiment, script templates are added to or deleted from the script scenario in such a way as to fit the statuses of the specified business program and business computer, in response to a request to copy, move or delete the business program. Selection and configuration of necessary script components and assignment of values into parameters are performed for the script scenario, to create the script. By executing the script, deployment and deletion of the business program can be performed easily without any particular attention to the business computer.

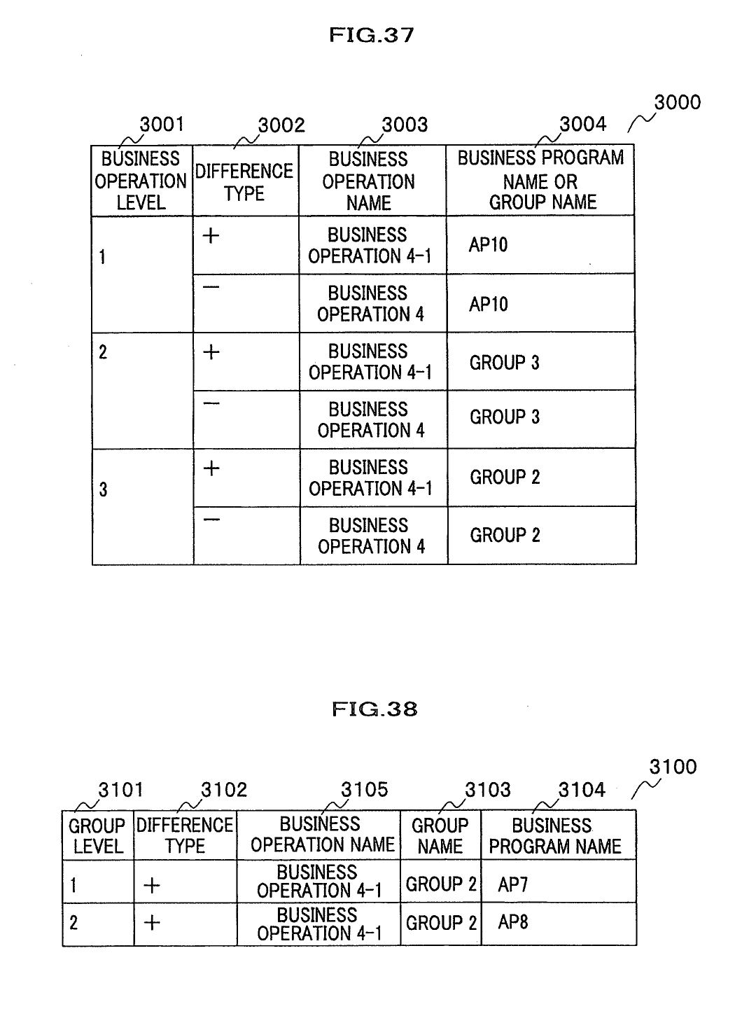

The following is a description, given with reference to FIGS. 37-41, of exemplary applicable implementations of the program deployment system S of the present embodiment.

FIG. 37 is an example of a business configuration difference information management table 3000 in which configuration difference information for business operations responsive to a request or event to copy, move or delete a business. This business configuration difference information management table 3000 is an expanded version of the program configuration difference information management table 105 (see FIG. 19), and may be stored, for example, together with the program configuration difference information management table 105, in the system configuration information 22 (see FIG. 4).

In this table 3000, information on a business coordination level 3001, a difference type 3002, a business operation name 3003, and a business program name or group name 3004 is recorded. In the fields of difference type 3002, ‘+’ is placed if the business operation is to be copied, and ‘−’ is placed if the business operation is to be deleted.

To move data on a business operation, the data on the pertinent business operation stored in a first business computer are copied into a second business computer, and thereafter the data in the first business computer are deleted. The business operation level 3001 represents dependency of a business program on coordinated programs with which each business operation (responsive to a copying or deleting request) is achieved in coordination with the business program; e.g., for a business program having no other program coordinated therewith, business operation level ‘1’ is assigned; for a business program having at least one program coordinated therewith, though no other program is coordinated with the at least one program, business operation level ‘2’ is assigned; for a business program having at least one first program coordinated therewith, while at least one second program is coordinated with the at least one second program, though no other program is coordinated with the at least one second program business operation level ‘3’ is assigned. In cases where any further coordinated program is coordinated with the second, third, . . . , nth program, business operation level ‘4’, ‘5’, . . . , ‘(n-2)’ may be assigned for the pertinent business program. The business operations are executed in a specific order based upon the business operation level; i.e., if a program or group is to be copied, the operation is executed in ascending order of the business operation level, while if a program or group is to be deleted, the operation is executed in descending order of the business operation level. Thus, the order of execution of business operations is determined based upon coordination relationship of the programs in the business operations and associated conditions, such that copying operation is executed sequentially from data to which higher priority is assigned while deleting operation is executed sequentially from data to which lower priority is assigned. This would reduce the likelihood of errors occurring during the process.

FIG. 38 is an example of a group configuration difference information management table 3100, in which the business program name or group name 3004 of the table 3000 as shown in FIG. 37 are substituted for a group name. This group configuration difference information management table 3100 is designed, like the business configuration difference information management table 3000, to be an extended version of the program configuration difference information management table 105 (see FIG. 19), and may be stored, for example, together with the program configuration difference information management table 105, in the system configuration information 22 (see FIG. 4).

In this table 3100, information on a group level 3101, a difference type 3102, a group name 3103, and a business program name 3104 are recorded. In the fields of difference type 3102, ‘+’ is placed if the business operation is to be copied, and ‘−’ is placed if the business operation is to be deleted.

The group level 3101 represents dependency of a business program on prerequisite programs (of program level ‘3’) with which each group of business programs executes a copying or deleting operation; e.g., for a business program having no other program prerequisite therefor, group level ‘1’ is assigned; for a business program having at least one program prerequisite therefor, though no other program is prerequisite for the at least one program, group level ‘2’ is assigned; for a business program having at least one first program prerequisite therefor, while at least one second program is prerequisite for the at least one second program, though no other program is prerequisite for the at least one second program, group level ‘3’ is assigned. In cases where any further prerequisite program is prerequisite for the second, third, . . . , nth program, group level ‘4’, ‘5’, . . . , ‘(n-2)’ may be assigned for the pertinent business program. The business programs are executed in a specific order based upon the group level; i.e., if a program is to be copied, the operation is executed in the ascending order of the group level, while if a program is to be deleted, the operation is executed in the descending order of the group level. Thus, the order of execution of business operations is determined, as in the embodiment illustrated in FIG. 37, based upon prerequisite relationship of the programs and associated conditions, such that copying operation is executed sequentially from data to which higher priority is assigned while deleting operation is executed sequentially from data to which lower priority is assigned. This would reduce the likelihood of errors occurring during the process.

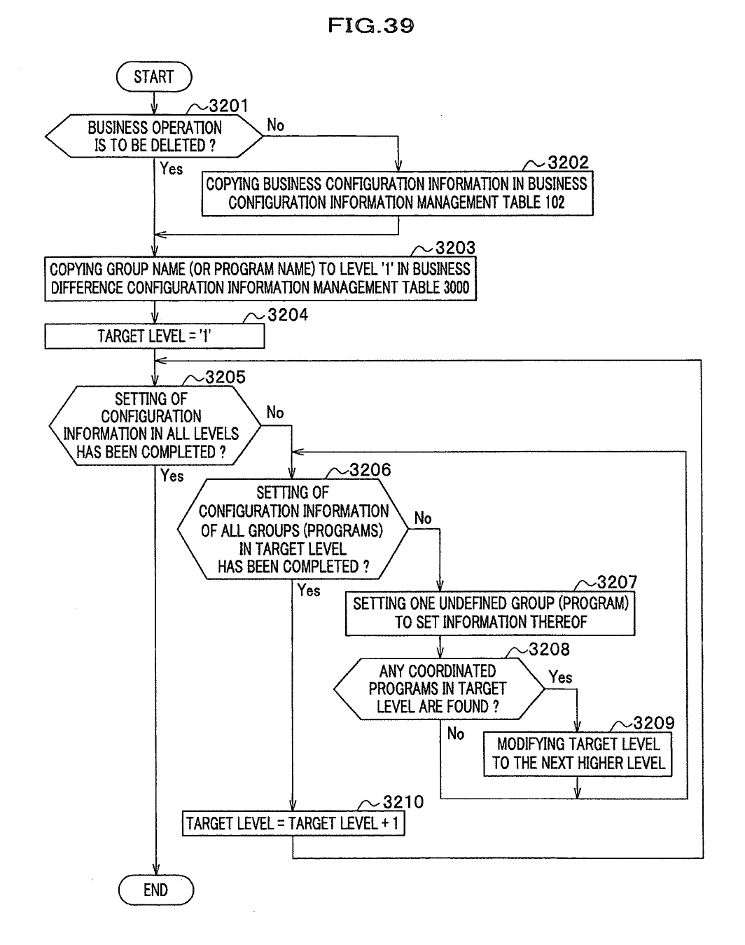

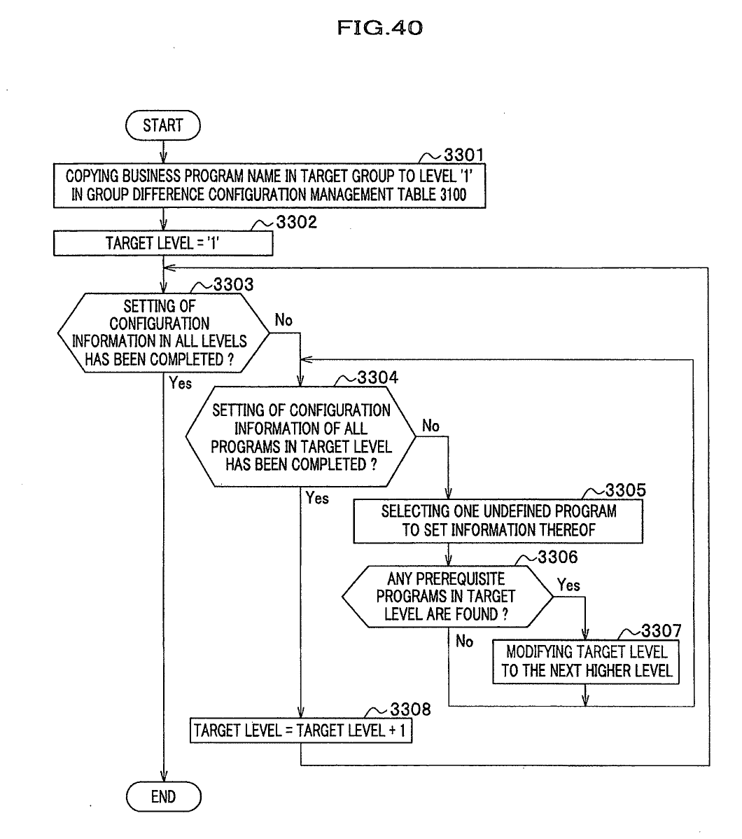

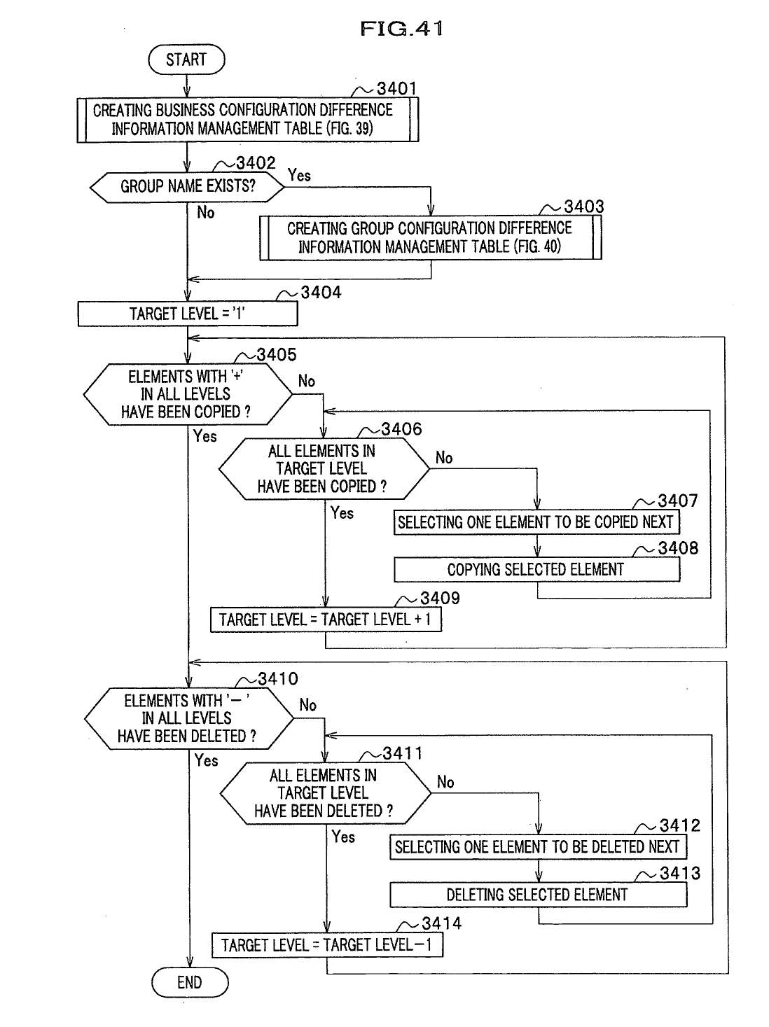

FIG. 39 is a flowchart showing an exemplary process of the managing computer 11 creating the business configuration difference information management table 3000. First, it is determined in step 3201 whether or not a business operation is to be deleted. If the business operation is to be deleted (Yes in step 3201), then the process goes to step 3203, while if the business program is to be copied (No in step 3201), then the process goes to step 3202.

In step 3202, the business configuration information for a business operation to be copied is copied in the business configuration information management table 102 (see FIG. 9) and saved therein with a different name attached thereto. For instance, when a business operation 1 is copied, a business operation 1-1 is created. In this instance, the business operation 1-1 has not been completed yet, the field of ‘computer name 604’ is left blank and to be filled in after a subsequent copying operation.

Next, in step 3203, the group name of the target business operation (or program name thereof if no group name is available) is copied from the business configuration information management table 102 to the corresponding field of level ‘1’ in the business configuration difference information management table 3000. At this stage, if the business operation is to be deleted (Yes in step 3201), ‘−’ is set to the field of difference type 3002, while if the business operation is to be copied (No in step 3201), ‘+’ is set to the field of difference type 3002.

Next, in step 3204, ‘1’ is set to the target level.

It is determined in step 3205 whether or not setting of configuration information in all the levels of the business configuration difference information management table 3000 has been completed. If setting of configuration information in all the levels has been completed (Yes in step 3205), then the process is terminated, but otherwise (No in step 3205), the process goes to step 3206.

It is determined in step 3206 whether or not setting of configuration information of all the groups (or programs) in the target level has been completed (Yes in step 3206), then the process goes to step 3210, but otherwise (No in step 3206), the process goes to step 3207.

In step 3207, one undefined group (or program) in the target level is selected so that configuration information of the selected group (or program) is set, and the process goes to step 3208.

In step 3208, the coordinated program name(s) of programs coordinated with the programs in the target group (or a program coordinated with the target program if no group is available) are/is searched for through the relevant fields 805 in the program configuration management table 101, and it is determined whether or not any coordinated program names corresponding to the programs coordinated with the programs in the target level are found in the table 101. If at least one program coordinated with the programs in the target level is found (Yes in step 3208), the process goes to step 3209, but otherwise (No in step 3208), the process goes to step 3206.

In step 3209, the target level for the group (or program) to be defined is modified to the next higher level (the target level plus one), and the process goes to step 3206.

In step 3210, the target level for the group (or program) to be defined next is given an increment of one level (i.e., Target Level=Target Level+1), and the process goes back to step 3205.

FIG. 40 is a flowchart showing an exemplary process of the managing computer 11 creating the group configuration difference information management table 3100. First, in step 3301, the business program name in the target group is copied from the business configuration information management table 102 to the corresponding field of level ‘1’ in the group configuration difference information management table 3100. At this stage, if the business operation is to be deleted, ‘−’ is set to the field of difference type 3302, while if the business operation is to be copied, ‘+’ is set to the field of difference type 3302.

Next, in step 3302, ‘1’ is set to the target level.

It is determined in step 3303 whether or not setting of configuration information in all the levels of the group configuration difference information management table 3100 has been completed. If setting of configuration information in all the levels has been completed (Yes in step 3303), then the process is terminated, but otherwise (No in step 3303), the process goes to step 3304.

It is determined in step 3304 whether or not setting of configuration information of all the programs in the target level has been completed. If the setting of configuration information of all the programs in the target level has been completed (Yes in step 3304), then the process goes to step 3308, but otherwise (No in step 3304), the process goes to step 3305.

In step 3305, one undefined program in the target level is selected so that configuration information of the selected program is set, and the process goes to step 3306.

In step 3306, the prerequisite program name(s) of programs prerequisite for the selected program in the target level are/is searched for through the relevant fields 804 in the program configuration management table 101 (see FIG. 1), and it is determined whether or not any prerequisite program names corresponding to the programs prerequisite for the selected program in the target level are found in the table 101. If at least one program prerequisite for the selected program in the target level is found (Yes in step 3306), the process goes to step 3307, but otherwise (No in step 3306), the process goes to step 3304.

In step 3307, the target level for the program to be defined is modified to the next higher level (the target level plus one), and the process goes to step 3304.

In step 3308, the target level for the program to be defined next is given an increment of one level (i.e., Target Level=Target Level+1), and the process goes back to step 3303.

FIG. 41 is a flowchart showing an exemplary process of the managing computer 11 copying, moving or deleting a business operation.

It is understood that the illustrated process relates to modification, such as copying, moving and deleting, made for each business operation rather than for each business program. In this embodiment, the managing computer 11 first initiates the process shown in FIG. 12, then proceeds to step 902, and makes, immediately after determination of ‘No’ in step 902, a determination for each business operation as to whether or not any modifications are to be made. If a determination is made such that modifications are to be made for each business operation, then the managing computer 11 starts the process as shown in FIG. 41. In step 3408 of FIG. 41, the managing computer 11 executes steps 906 to 909; in step 3413 of FIG. 41, the managing computer 11 executes steps 911 and 912.

It is also to be understood that the determination for each business operation as to whether or not modifications are to be made may be made at a time, other than that which immediately follows determination of ‘No’ in step 902 of FIG. 12, which includes that which comes immediately after determination of ‘No’ in step 910 or 913.

Referring now to FIG. 41, first, a business configuration difference information management table is created in step 3401 (for details, see FIG. 39).

Next, it is determined in step 3402 whether or not a group name is set in the field of business program name or group name 3004 of the created business configuration difference information management table 3000. If at least one group name is found therein (Yes in step 3402), then the process goes to step 3403 where the group configuration difference information management table 3100 is created for each group of which the group name is found in step 3402 (for details, see FIG. 40).

Next, in step 3404, ‘1’ is set to the target level, and the process goes to step 3405.

It is determined in step 3405 whether or not elements (groups or programs) with ‘+’ assigned to the difference type 3002 field thereof in all the levels in the created business configuration difference information management table 3000 have been copied. If the elements in all the levels have already been copied (Yes in step 3405), then the process goes to step 3410, but otherwise (No in step 3405), the process goes to step 3406.

It is determined in step 3406 whether or not all the elements in the target level have been copied. If all the elements in the target level have already been copied (Yes in step 3406), then the process goes to step 3409, but otherwise (No in step 3406), the process goes to step 3407.

In step 3407, one element to be copied next is selected, and the process goes to step 3408.

In step 3408, the selected element is copied. At this stage, if the element is a program, then a copying event for the program is output, while if the element is a group, then copying events for business programs identified by the business program name 3104 are output in the descending order of group level 3101 in the corresponding group configuration difference information management table 3100.

In step 3409, the target level for the program to be executed next is given an increment of one level (i.e., Target Level=Target Level+1), and the process goes to step 3405.

Next, it is determined in step 3410 whether or not elements (groups or programs) with ‘−’ assigned to the difference type 3002 field thereof in all the levels in the created business configuration difference information management table 3000 have been deleted. If the elements in all the levels have already been deleted (Yes in step 3410), then the process is terminated, but otherwise (No in step 3410), the process goes to step 3411.

It is determined in step 3411 whether or not all the elements in the target level have been deleted. If all the elements in the target level have already been deleted (Yes in step 3411), then the process goes to step 3414, but otherwise (No in step 3411), the process goes to step 3412.

In step 3412, one element to be deleted next is selected, and the process goes to step 3413.

In step 3413, the selected element is deleted. At this stage, if the element is a program, then a deleting event for the program is output, while if the element is a group, then deleting events for business programs identified by the business program name 3104 are output in the ascending order of group level 3101 in the corresponding group configuration difference information management table 3100.

In step 3414, the target level for the program to be executed is modified to the next lower level (the target level minus one), and the process goes to step 3410.

According to the above-described embodiment, even when modifications, such as copying, moving or deleting, are to be made for each business operation, determination of the order of modifications of the business programs and setting of configuration of various kinds can be executed automatically, whereby the business system configuration can be modified with increased ease.

The method for modifying configuration of a business system as implemented by the program deployment system S of the above-described embodiments may be embodied by a computer and a computer program. The computer program may be stored in a computer-readable recording medium, and thus can be distributed as a program product. Also the computer program may be provided (installed and/or executed) via network.

In one aspect of the present invention, there is provided a computer program embodied on a computer readable medium, for a managing computer communicatively coupled with at least one business computer to modify configuration of a business system embodied by the at least one business computer executing a plurality of business programs. In one embodiment, the managing computer comprises a processing unit and a storage unit in which business system configuration information, a first set of data, a second set of data and a plurality of script components are stored. The business system configuration information represents configuration of the plurality of business programs in the business system. The first set of data comprises operating condition information and business computer information which are associated with each other. The operating condition information represents conditions on which the plurality of business programs are operable, and the business computer information represents an identifier for the at least one business computer compatible with the operating conditions. The second set of data comprises prerequisite information representing programs which are prerequisite for the plurality of business programs and classified in program levels. The plurality of script components into which at least one parameter is recordable are provided for use in composing a script executable by the managing computer. The at least one parameter including a parameter for specifying an identifier for the at least one business computer to be executed. The computer program is configured to cause the processing unit of the managing computer to run a managing process which comprises a process for deploying a business program.

In one embodiment, the computer program comprises a selecting module, a searching module, a determining module, an obtaining and arranging module, and a deploying module. The selecting module is configured to select at least one business computer compatible with operating conditions of the business program by performing a lookup on the first set of data stored in the storage unit. The searching module is configured to search for programs prerequisite for the business program by performing a lookup on the second set of data stored in the storage unit. The determining module is configured to determine differences in the business system configuration information between pre-modification configuration and post-modification configuration of the business system with respect to the business program and the programs prerequisite for the business program determined by the searching module. The obtaining and arranging module is configured to obtain some of the plurality of script components required to apply the differences determined by the determining module, to the configuration of the business system, and to arrange the obtained script components in an order determined on the basis of the prerequisite information stored in the storage unit, to compose the script. The deploying module is configured to deploy the business program to the at least one business computer selected by the selecting module, by executing the script composed by the obtaining and arranging module. The computer program may further comprise an installation module for implementing the managing computer as described above on general-purpose hardware equipment.

Although various exemplary embodiments of the present invention have been described above, the present invention is not limited to the illustrated embodiments. It is contemplated that numerous modifications may be made to the exemplary embodiments of the invention without departing from the spirit and scope of the embodiments of the present invention as defined in the appended claims.

For example, the above embodiments provide a monitoring computer provided with a display screen (GUI). However, it is appreciated that the managing computer may be provided with a display function such as GUI, and in such an alternative embodiment, the monitoring computer is not necessary.

In cases where a plurality of computers are provided in which business programs are deployable, a computer on which an OS ensuring a high security level is deployed may be prioritized in determining the business computer in which the business programs are to be deployed.

According to the present invention, configuration of a business system can be modified with increased ease.

What is claimed is:

1. A method for modifying a configuration of a business system embodied by at least one business computer executing a plurality of business programs, the method comprising:
providing a managing computer communicatively coupled with the at least one business computer, the managing computer comprising a processing unit and a storage unit in which business system configuration information, a first set of data, a second set of data and a plurality of script components are stored, wherein the business system configuration information represents configuration of the plurality of business programs in the business system, wherein the first set of data comprises operating condition information and business computer information which are associated with each other, the operating condition information representing conditions on which the plurality of business programs are operable, the business computer information representing an identifier for the at least one business computer compatible with the operating conditions, wherein the second set of data comprises prerequisite information representing programs which are prerequisite for the plurality of business programs and classified in program levels, and wherein the plurality of script components into which at least one parameter is recordable are provided for use in composing a script executable by the managing computer, the at least one parameter including a parameter for specifying an identifier for the at least one business computer to be executed, and
causing the processing unit, when deploying a business program, to execute the following steps of:
selecting at least one business computer compatible with operating conditions of the business program by performing a lookup on the first set of data;
searching for programs prerequisite for the business program by performing a lookup on the second set of data;
determining differences in the business system configuration information between pre-modification configuration and post-modification configuration of the business system with respect to the business program and the programs prerequisite for the business program determined in the searching step;
obtaining some of the plurality of script components required to apply the differences determined in the determining step, to the configuration of the business system, and arranging the obtained script components in an order determined on the basis of the prerequisite information, to compose the script; and
deploying the business program to the at least one business computer selected in the selecting step, by executing the script composed in the obtaining and arranging step.

2. The method according to claim 1, further comprising causing the processing unit, when deleting a business program among the plurality of business programs which are deployed, to execute the steps of:
obtaining some of the plurality of script components required to delete the business program, to compose a deleting script; and
deleting the business program by executing the deleting script composed in the obtaining step.

3. The method according to claim 1, further comprising causing the processing unit to execute the step of receiving a DEPLOY instruction input by an operator through an entry screen displayed on a monitoring computer connected with the managing computer, wherein the processing unit is caused to execute the steps in accordance with the DEPLOY instruction received in the receiving step.

4. The method according to claim 2, further comprising causing the processing unit to execute the step of receiving a MOVE instruction input by an operator through an entry screen displayed on a monitoring computer connected with the managing computer, wherein the processing unit is caused to execute the steps in accordance with the MOVE instruction received in the receiving step so that the business program is deleted and deployed to thereby move from one location to another.

5. The method according to claim 1, wherein the obtaining and arranging step comprises:
deleting an unnecessary portion of the script components from a plurality of script templates, which are stored in the storage unit and represent typical combination patterns of the plurality of script components, by performing a lookup on the business system configuration information; and
collecting the plurality of script templates from which the unnecessary portion of the script components is deleted, to compose the script.

6. The method according to claim 1, further comprising causing the processing unit to execute the step of setting parameters of the script components obtained in the obtaining and arranging step, by performing a lookup on pre-modification configuration and post-modification configuration in the business system configuration information stored in the storage unit.

7. The method according to claim 1, wherein the selecting step comprises selecting, if the lookup performed on the first set of data shows that there are several alternative business computers compatible with operating conditions of the business program, one business computer having a largest number of patch files for modification of an operating system which are prerequisite for the business program, as a computer on which the business program is to be deployed, among the alternative business computers.

8. The method according to claim 1, wherein each of the plurality of script components stored in the storage unit comprises a reboot indicator in which a reboot flag is set if the script component requires rebooting the business computer, and
wherein the deploying step comprises rebooting the at least one business computer on which any of the business program and programs prerequisite for the business program are deployed after executing the script, if at least one of the following conditions are satisfied: (i) the reboot flag is set in the reboot indicator of a script component making up the executed script, and (ii) a REBOOT request has been issued to the at least one business computer.

9. The method according to claim 1, wherein the first set of data comprises an operating system information management table in which information on operating systems deployable in each of the at least one business computer is recorded.

10. The method according to claim 1, wherein the second set of data comprises a program configuration management table in which information on patch files for modification of each operating system which are prerequisite for each of the plurality of business programs, programs prerequisite for each of the plurality of business programs, and programs operating in coordination with each of the plurality of business programs is recorded.

11. The method according to claim 1, wherein the second set of data comprises a physical configuration information management table in which information on an operating system running on the at least one business computer, patch files applied for modification to the operating system running on the at least one business computer, and programs deployed in the at least one business computer is recorded.

12. A managing computer communicatively coupled with at least one business computer, for modifying a configuration of a business system embodied by the at least one business computer executing a plurality of business programs, the managing computer comprising:
a processing unit;
a storage unit in which business system configuration information, a first set of data, a second set of data and a plurality of script components are stored, wherein the business system configuration information represents configuration of the plurality of business programs in the business system, wherein the first set of data comprises operating condition information and business computer information which are associated with each other, the operating condition information representing conditions on which the plurality of business programs are operable, the business computer information representing an identifier for the at least one business computer compatible with the operating conditions, wherein the second set of data comprises prerequisite information representing programs which are prerequisite for the plurality of business programs and classified in program levels, and wherein the plurality of script components into which at least one parameter is recordable are provided for use in composing a script executable by the managing computer, the at least one parameter including a parameter for specifying an identifier for the at least one business computer to be executed; and
a managing program for causing the processing unit to run a managing process which comprises a process for deploying a business program, the managing program comprising:
a selecting module for selecting at least one business computer compatible with operating conditions of the business program by performing a lookup on the first set of data stored in the storage unit;
a searching module for searching for programs prerequisite for the business program by performing a lookup on the second set of data stored in the storage unit;
a determining module for determining differences in the business system configuration information between pre-modification configuration and post-modification configuration of the business system with respect to the business program and the programs prerequisite for the business program determined by the searching module;
an obtaining and arranging module for obtaining some of the plurality of script components required to apply the differences determined by the determining module, to the configuration of the business system, and arranging the obtained script components in an order determined on the basis of the prerequisite information stored in the storage unit, to compose the script; and
a deploying module for deploying the business program to the at least one business computer selected by the selecting module, by executing the script composed by the obtaining and arranging module.

13. The managing computer according to claim 12, wherein the managing process further comprises a process for deleting a business program among the plurality of business programs which are deployed, and the managing program further comprises:
an obtaining module for obtaining some of the plurality of script components required to delete the business program, to compose a deleting script; and
an deleting module for deleting the business program by executing the deleting script composed by the obtaining module.

14. The managing computer according to claim 12, wherein the managing program further comprises a receiving module for receiving a DEPLOY instruction input by an operator through an entry screen displayed on a monitoring computer connected with the managing computer, wherein the processing unit is caused to execute the managing process in accordance with the DEPLOY instruction received by the receiving module.

15. The managing computer according to claim 13, wherein the managing program further comprises a receiving module for receiving a MOVE instruction input by an operator through an entry screen displayed on a monitoring computer connected with the managing computer, wherein the processing unit is caused to execute the managing process in accordance with the MOVE instruction received by the receiving module so that the business program is deleted and deployed to thereby move from one location to another.

16. The managing computer according to claim 12, wherein the obtaining and arranging module comprises:
a script component deleting module for deleting an unnecessary portion of the script components from a plurality of script templates, which are stored in the storage unit and represent typical combination patterns of the plurality of script components, by performing a lookup on the business system configuration information stored in the storage unit; and
a collecting module for collecting the plurality of script templates from which the unnecessary portion of the script components is deleted, to compose the script.

17. The managing computer according to claim 12, wherein the managing program further comprises a parameter setting module for setting parameters of the script components obtained by the obtaining and arranging module, by performing a lookup on pre-modification configuration and post-modification configuration in the business system configuration information stored in the storage unit.

18. The managing computer according to claim 12, wherein the selecting module comprises a further selecting module for selecting, if the lookup performed on the first set of data shows that there are several alternative business computers compatible with operating conditions of the business program, one business computer having a largest number of patch files for modification of an operating system which are prerequisite for the business program, as a computer on which the business program is to be deployed, among the alternative business computers.

19. The managing computer according to claim 12, wherein each of the plurality of script components stored in the storage unit comprises a reboot indicator in which a reboot flag is set if the script component requires rebooting the business computer, and
wherein the deploying module comprises a rebooting module for rebooting the at least one business computer on which any of the business program and programs prerequisite for the business program are deployed after executing the script, if at least one of the following conditions are satisfied: (i) the reboot flag is set in the reboot indicator of a script component making up the executed script, and (ii) a REBOOT request has been issued to the at least one business computer.

20. A computer program embodied on a computer readable medium, for a managing computer communicatively coupled with at least one business computer to modify a configuration of a business system embodied by the at least one business computer executing a plurality of business programs, the managing computer comprising a processing unit and a storage unit in which business system configuration information, a first set of data, a second set of data and a plurality of script components are stored, wherein the business system configuration information represents configuration of the plurality of business programs in the business system, wherein the first set of data comprises operating condition information and business computer information which are associated with each other, the operating condition information representing conditions on which the plurality of business programs are operable, the business computer information representing an identifier for the at least one business computer compatible with the operating conditions, wherein the second set of data comprises prerequisite information representing programs which are prerequisite for the plurality of business programs and classified in program levels, and wherein the plurality of script components into which at least one parameter is recordable are provided for use in composing a script executable by the managing computer, the at least one parameter including a parameter for specifying an identifier for the at least one business computer to be executed,
wherein the computer program is configured to cause the processing unit of the managing computer to run a managing process which comprises a process for deploying a business program, the computer program comprising:
a selecting module for selecting at least one business computer compatible with operating conditions of the business program by performing a lookup on the first set of data stored in the storage unit;
a searching module for searching for programs prerequisite for the business program by performing a lookup on the second set of data stored in the storage unit;
a determining module for determining differences in the business system configuration information between pre-modification configuration and post-modification configuration of the business system with respect to the business program and the programs prerequisite for the business program determined by the searching module;
an obtaining and arranging module for obtaining some of the plurality of script components required to apply the differences determined by the determining module, to the configuration of the business system, and arranging the obtained script components in an order determined on the basis of the prerequisite information stored in the storage unit, to compose the script; and
a deploying module for deploying the business program to the at least one business computer selected by the selecting module, by executing the script composed by the obtaining and arranging module.
